(19) United States
(12) Patent Application Publication
(10) Pub. No.: US 2010/0276108 A1
(43) Pub. Date: Nov. 4, 2010

(54) 7XXX WELD FILLER ALLOYS AND METHODS OF USING THE SAME

(76) Inventors: Israel Stol, Pittsburgh, PA (US); Jen C. Lin, Export, PA (US); Kyle L. Williams, Shelocta, PA (US); Daniel W. Gaydos, New Kensington, PA (US)

Correspondence Address: INTELLECTUAL PROPERTY, ALCOA TECHNICAL CENTER, BUILDING C, 100 TECHNICAL DRIVE, ALCOA CENTER, PA, 15069-0001, US

(21) Appl. No.: 12/763,277

(22) Filed: Apr. 20, 2010

Related U.S. Application Data
(60) Provisional application No. 61/173,914, filed on Apr. 29, 2009.

(51) Int. Cl. B22D 17/00; B23K 31/02

(52) U.S. Cl. 164/303; 228/119

(57) ABSTRACT

7xxx aluminum alloy weld filler alloys and methods of using the same are described. The 7xxx aluminum alloy weld filler alloys may be used to repair 7xxx alloy products. The repaired volume of the 7xxx alloy products may be substantially crack-free, and may facilitate reuse of the repaired 7xxx alloy products.

### CROSS REFERENCE TO RELATED APPLICATIONS

This application claims priority to U.S. Provisional Patent Application Ser. No. 61/173,914 filed Apr. 29, 2009, which is incorporated herein by reference in its entirety.

### BACKGROUND

7xxx aluminum alloys, especially in thick plate form, have found use in the molding industry. These 7xxx alloy products may be subjected to intense conditions, which may result in damage to the surface of the products. Repairing such products so that they can continue to be used to produce molded parts has proved problematic, for example, with fusion-based processes such as gas tungsten arc welding (GTAW).

### SUMMARY

7xxx aluminum alloy weld filler alloys and methods of using the same are disclosed. In one embodiment, a method of using a weld filler aluminum alloy to repair a mold block or mold plate having a surface defect is disclosed. The method includes locating a surface defect on the mold block. The surface defect, having a first volume, may be at least partially surrounded by an original volume. The mold block, including the original volume, may be made of a wrought aluminum alloy. The wrought aluminum alloy may be a first 7xxx series aluminum alloy. The repairing step of the surface defect includes fusion welding the weld filler aluminum alloy to at least a portion of the original volume to produce a repaired volume. Like the wrought aluminum alloy, the weld filler alloy may be a second 7xxx series aluminum alloy. After the repairing process, the repaired volume may include the first volume of the surface defect and at least a portion of the original volume.

In one embodiment, the first 7xxx series aluminum alloy and the second 7xxx series aluminum alloy may have substantially the same composition. In another embodiment, the first 7xxx series aluminum alloy is selected from the group consisting of 7085, 7140, 7040, 7X36, 7X49, 7X50, 7055, 7056, 7X75, 7081, and 7095. In some embodiments, the first and second 7xxx series aluminum alloys include at least about 0.5 wt. % Cu, or at least about 1.0 wt. % Cu. In other embodiments, the first and second 7xxx series aluminum alloys include from about 6.0 wt. % Zn to about 9.5 wt. % Zn and from about 1.0 wt. % Mg to about 3.1 wt. % Mg.

In one embodiment, after the repairing step, a molded object may be produced using the repaired mold block, whereby the molded object may have substantially the same color throughout its outer surface (e.g., the surface that comes in direct contact with the injection molded plastic). In some instances, the molded object may have substantially the same texture throughout its outer surface (e.g., the surface that comes in direct contact with the injection molded plastic). In other instances, after the repairing step, the repaired volume may be substantially crack-free.

In one embodiment, the fusion welding step includes building up a repaired layer to a thickness of at least about 0.25 inch above the outer surface of the mold block. In some instances, after the building up step, the repaired layer may have a thickness of at least about 1 inch above the outer surface of the mold block, where the weld-repair build up may be produced by deposition of multiple weld passes next to and on top of each other.

In one embodiment, a 7xxx injection mold block having features suited for the production of injection molded parts is disclosed. The injection mold block consists essentially of a 7xxx aluminum alloy. In addition, the injection mold block may include a repaired volume and an adjacent original volume. In certain instances, the repaired volume may include a 7xxx weld filler alloy welded to the original volume. The repaired volume may be substantially crack-free. In some embodiments, the repaired volume may have an average height that is at least about 0.25 inch higher than that of the original volume. In other embodiments, the repaired volume may have an ultimate tensile strength of at least about 170 MPa.

Other variations, embodiments and features of the present disclosure will become evident from the following detailed description, drawings and claims.

### BRIEF DESCRIPTION OF THE DRAWINGS

FIG. 1 is a schematic view of one embodiment of a 7xxx mold plate having a surface defect.

FIG. 2 is a schematic view of one embodiment of a 7xxx mold plate having a repaired volume.

FIG. 3 is a flow chart illustrating one embodiment of a method useful in accordance with the present disclosure.

FIG. 4 is an aluminum alloy mold plate having a discontinuity formed therein to demonstrate fusion welding repair of the mold plate.

FIG. 5 shows cross-sectional views of repairs of the mold plate with an AA2319 aluminum alloy weld filler alloy.

FIG. 6 shows cross-sectional views of repairs of the mold plate with an AA7085 aluminum alloy weld filler alloy.

FIG. 7 shows cross-sectional views of repairs of the mold plate with a TiB₂ modified AA7085 aluminum alloy weld filler alloy.

FIG. 8 is the aluminum alloy mold plate having been filled by welding with a TiB₂ modified AA7085 aluminum alloy weld filler alloy.

FIG. 9 shows two run-in and run-off tabs coupled to a mold plate for demonstrating a weld build-up by deposition of one or more weld passes onto a mold plate.

FIG. 10 shows corners of the run-in and run-off tabs being tack-welded to a mold plate.

FIG. 11 shows abrading of welding areas with a stainless steel brush after cleaning with a solvent.

FIG. 12 shows grinding of welding areas with a hand-held router.

FIG. 13 shows solvent cleaning and drying of the welding areas, on top of the mold plate, in preparation for deposition of a weld build up.

FIG. 14 shows a filler wire being weld deposited on the run-in tab followed by the top of the mold plate and run-off tab using manual gas tungsten arc welding (GTAW) process.

FIG. 15 shows three weld deposits produced across portions of the run-in and run-off tabs and mold plate.

FIGS. 16-17 are top and side perspective views of built-up weld deposits produced with the AA7085 filler alloy with a variety of thicknesses (e.g., heights).

FIG. 18 shows top perspective view of weld deposits produced with the AA2319 filler alloy with a variety of thicknesses (e.g., heights)

FIG. 19 shows top perspective view of weld deposits produced with the AA7085 filler alloy being inspected with the dye-penetrant test for soundness (e.g., absence of open surface discontinuities).

FIG. 20 shows top perspective view of weld deposits produced with the AA2319 filler alloy being inspected with the dye-penetrant test for soundness (e.g., absence of open surface discontinuities).

FIGS. 21-22 are top and side perspective views of weld build-up deposits produced with the AA7085 filler alloy having substantially planar surfaces via machining.

FIG. 23 shows top perspective view of weld build-up deposits produced with the AA2319 filler alloy having substantially planar surfaces via machining

FIG. 24 shows top perspective view of substantially planar weld deposits produced with the AA7085 filler alloy being inspected with the dye-penetrant test for soundness (e.g., absence of open surface discontinuities).

FIG. 25 shows top perspective view of substantially planar weld deposits produced with the AA2319 filler alloy being inspected with the dye-penetrant test for soundness (e.g., absence of open surface discontinuities).

FIGS. 26-27 are cross-sectional macro/micrographs (15×/100×) through weld deposits produced with AA7085-based filler alloy.

FIGS. 28-29 are cross-sectional macro/micrographs (15×/100×) through weld deposits produced with AA2319-based filler alloy.

FIG. 30 shows a top perspective view of multiple troughs machined out of a mold plate in preparation for demonstrating the weld-repair filling technique with the new AA7085 weld filler alloy compared to the AA3219 weld filler alloy.

FIG. 31 shows a top perspective view of deposits produced by filling the machined troughs with the AA7085 and AA2319 filler alloys thus simulating areas where discrepant features have been removed (FIG. 30).

FIG. 32 shows a top perspective view of weld deposits produced with the AA7085 and AA2319 filler alloys, whose weld beads have been machined flash with the top surface of the mold plate, to which a dye-penetrant is being applied, prior to the dye-penetrant test.

FIG. 33 shows a top perspective view of the surface of the mold plate of FIG. 32 with the weld-repairs filling the troughs machined flash with the top surface of the mold plate, onto which a weld developer is being applied, following the application and removal of the dye-penetrant (FIG. 32).

FIG. 34 shows cross-sectional macro/micrographs (15×/100×) of defects repaired with weld deposits produced with the AA2319 filler alloy.

FIG. 35 shows cross-sectional macro/micrographs (15×/100×) of defects repaired with weld deposits produced with the AA7085 filler alloy.

FIG. 36 is a graph showing the relationship between ultimate tensile strength (UTS) and percentage elongation (E) of weld deposits produced with the AA7085 and AA2319 filler alloys.

FIG. 37 shows photographs of two different textured finishes of a mold plate repaired with the AA7085 filler alloy.

FIG. 38 shows photographs of resulting resin test of two different textured finishes of a mold plate filled and repaired with the AA7085 filler alloy.

### DETAILED DESCRIPTION OF THE DISCLOSURE

It will be appreciated by those of ordinary skill in the art that the welding repair and mold plate repaired using the disclosed methods, systems and apparatus can be embodied in other specific forms without departing from the spirit or essential character thereof. The presently disclosed embodiments are therefore considered in all respects to be illustrative and not restrictive. Reference is now made to the accompanying drawings, which at least assist in illustrating various pertinent features of the disclosure.

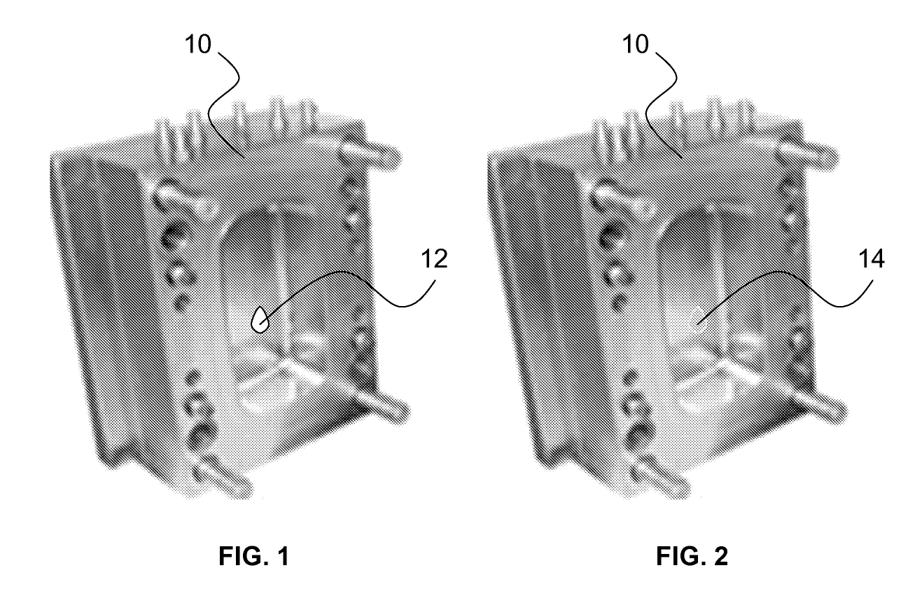

The instant application relates to 7xxx aluminum weld filler alloys and methods of using the same. These weld filler alloys may facilitate improved welding characteristics, such as when employed to repair 7xxx alloy products. For example, and with reference now to FIG. 1, a 7xxx mold plate 10 includes features suited for the production of mold parts. A surface defect 12 of a 7xxx mold plate 10 may be produced via normal production operations. This surface defect (sometimes called a discontinuity) may be repaired with the new 7xxx weld filler alloys to produce repaired 7xxx mold plates.

A surface defect, is a defect on the surface of the 7xxx alloy product that inhibits or prevents the use of the 7xxx alloy product in its intended environment. Examples of surface defects 12 that generally occur in 7xxx mold plates 10 include cracks open to the surface and/or worn out portions of the mold plate 10. Generally, a surface defect 12 has a depth of not greater than about 6.4 mm (0.25 inch), but in some instances has a depth greater than about 6.4 mm (0.25 inch). In one embodiment, the surface defect 12 has a depth in the range of from about 0.025 mm (0.001 inch) to about 3.2 mm (0.125 inch).

A mold plate (sometimes called a mold block) is a plate that is used to mold parts, with processes such as injection molding or blow molding. As illustrated in FIG. 2, the repaired portion 14 of the repaired 7xxx mold plates 10 is intended to facilitate substantially the same appearance (e.g., texture, color match) and function (e.g., thermo-mechanical, abrasion resistance) on the applicable outer surface of products produced with the 7xxx mold plate 10, which may facilitate the reuse of the repaired 7xxx mold plates 10. The repaired 7xxx mold plates 10 may also realize enhanced functional characteristics (e.g., durability, strength), which may also facilitate the reuse of the repaired 7xxx mold plates 10. In the end, the lifetime of the 7xxx mold plates 10 may be substantially increased via use of the new 7xxx based weld filler alloys.

The new 7xxx weld filler alloys disclosed herein are 7xxx aluminum alloys in the form of a weld filler alloy produced in the form of a rod for manual gas tungsten arc welding (GTAW) or continuous wire for welding with the gas metal arc welding (GMAW) process. A weld filler alloy is an alloy that is used to weld or repair an aluminum alloy product. Examples of weld filler alloys forms include weld rods, weld wires and powders that can be clad over a repair area (e.g., with the aid of a laser beam welding process). Other weld filler alloy forms may be used. 7xxx aluminum alloys are aluminum alloys comprising Zn as a primary alloying constituent. 7xxx aluminum alloys may also include one or more of Cu, Mg and Mn, among others elements, as alloying constituents. Some examples of 7xxx aluminum alloys include any of the 7xxx series alloys defined by the Aluminum Association, including Al—Zn—Mg, Al—Zn—Cu, Al—Zn—Cu—Mg and other similar alloys. Some 7xxx aluminum alloys useful as a weld filler alloy include Aluminum Association alloys 7085, 7140, 7040, 7X36, 7X49, 7X50, 7055, 7056, 7X75, 7081, and 7095, among others. In one particular embodiment, the 7xxx weld filler alloy is AA7085.

The 7xxx weld filler alloys are generally used to repair a 7xxx alloy product. A 7xxx alloy product is a product containing a predominate amount of at least one 7xxx aluminum alloy, such as any wrought product (e.g., rolled products, extrusions), cast product (e.g., castings) or forged product (e.g., forgings). In one embodiment, a product to be repaired is a 7xxx mold plate, as described above. In one embodiment, the 7xxx weld filler alloy has a substantially similar composition to the 7xxx alloy product being repaired. For example, a mold plate may be made from AA7085. The weld filler alloy of the instant disclosure may also be made of AA7085. These alloys have a substantially similar composition because they are made from the same Aluminum Association alloy, 7085, but may have minor differences in composition either due to the inherent nature of aluminum alloys production, or due to deliberate, but minor, modifications to the alloy composition. The use of 7xxx weld filler alloys having a substantially similar composition to the 7xxx alloy products being repaired have been found to facilitate the repair of such 7xxx alloy products.

For example, since the product and the weld filler alloy have substantially the same composition, the 7xxx alloy product and the 7xxx weld filler alloy have a substantially similar solidus temperature. Solidus temperature is the temperature at which a given substance solidifies and/or crystallizes completely. A substantially similar solidus temperature means that a first material has a solidus temperature that is not more than 5° C. different than the solidus temperature of a second material. For example, a 7xxx weld filler alloy may have a solidus temperature that is no more than 5° C. different (+/−) than the solidus temperature of a 7xxx alloy product.

In another example, since the product and the weld filler alloy have substantially the same composition, the 7xxx alloy product and the 7xxx weld filler alloy have a substantially similar coefficient of thermal expansion. Coefficient of thermal expansion is the ratio of dimensional change of a material from an original dimension when temperature changes. A substantially similar coefficient of thermal expansion means that a first material has a coefficient of thermal expansion that is not greater than about 5 ppm/° C. different (+/−) than the coefficient of thermal expansion of a second material. For example, a 7xxx weld filler alloy may have a coefficient of thermal expansion that is no more than 5 ppm/° C. different (+/−) than the coefficient of thermal expansion of a 7xxx alloy product.

In one specific example, weld filler alloys produced from AA7085 have been found to facilitate repair of AA7085 aluminum alloy products, while achieving comparable (or even better) welding characteristics than that of prior art aluminum alloy AA2319, including appearance characteristics (e.g., color match, texture) and functional characteristics (e.g., durability, wear resistance, pitting, adhesion, hardness, thermal shock, impact shock). AA2139 is Aluminum Association alloy 2319 as defined by the Aluminum Association Teal Sheets.

In one embodiment, fusion welding is used to repair the 7xxx alloy product with the 7xxx weld filler alloy. Fusion welding means to join at least two portions together such as by one or more of heating, melting, fusing and metallurgically coalescing, and combinations thereof, such as with the assistance of a weld filler alloy. Examples of some types of welding processes include gas tungsten arc welding (GTAW), shielded metal arc welding (SMAW), gas metal arc welding (GMAW), plasma arc welding (PAW) and laser beam welding (LBW), to name a few. In one embodiment, fusion welding includes at least one of trough filling and build-up welding.

“Trough filling” means that the “trough” leftover from the removal of the defective areas (e.g., cracks) on the mold plate is “filled” by depositing one or more weld-repair passes, which upon solidification results in sounder (e.g., substantially defect free) deposits, which constitute the repaired areas. In some instances, trough filling may also be referred to as weld repair.

“Build-up” means that the weld-repair of worn portions on the mold plates or locales needed geometric alterations (e.g., addition of a feature such as a step or a ledge to achieve the desired flow of the injection molded plastic and/or addition of a feature to the plate) are carried out by deposition of single or multiple weld passes onto the top and/or adjacent to each other. In some instances, build-up may also be referred to as weld restoration.

As described above, the new 7xxx weld filler alloys may facilitate production of a repaired 7xxx alloy product, where the repaired 7xxx alloy product has a uniform appearance, such as after texturizing operations, described below. For example, after repairing a 7xxx mold plate with the new 7xxx weld filler alloy, the repaired portion (e.g., the weld deposit) of the 7xxx alloy product may have substantially the same appearance as the original, non-repaired portions of the 7xxx mold plate, after texturizing operations.

In one embodiment, the appearance relates to color match on products produced with the repaired 7xxx alloy product. In one embodiment, an object produced from a repaired 7xxx alloy product has substantially the same color on its outer surface, including those outer surfaces that were in contact with the repaired portion. A repaired portion is substantially the same color and appearance when, as viewed with the naked eye, it appears to have the same color as that of the original portion of the product, when viewed with 20/20 vision and lighting conditions comparable to normal, sunny outdoor lighting. In another embodiment, the Delta-E relative to the repaired and non-repaired portions is not greater than about 1.0 as determined via CIELAB analysis. In other embodiments, the Delta-E relative to the repaired and non-repaired portions is not greater than about 0.9, or not greater than about 0.8, or not greater than about 0.7, or not greater than about 0.6, or not greater than about 0.5, or less, as determined via CIELAB analysis.

As known to those skilled in the art, Delta-E is a number that represents the distance (difference) between two colors. Delta-E may be measured using LCH, LAB and other color parameters, and via a consistent illumination source (e.g., white light of a defined wavelength and wattage output) at a consistent, specified distance between the light and the substrate, and via one of the various Delta-E equations. In one embodiment, the Delta-E equation is based on dE76. In one embodiment, the Delta-E equation is based on dE94. In one embodiment, the Delta-E equation is based on dE-CMC. In one embodiment, the Delta-E equation is based on dE-CMC 2:1. In one embodiment, the Delta-E equation is based on dE2000.

In one embodiment, the objects produced from a repaired 7xxx alloy product have substantially the same texture on the outer surface of the object, including those outer surfaces that were in contact with the repaired portion. A surface has substantially the same texture on its outer surface when the grain size and/or grain orientation of the object closely replicates, and in some instances completely replicates, that of the original grain portion (e.g., as traced to a master plaque).

In one embodiment, after a welding step, the repaired portion of a 7xxx alloy product is substantially free of cracks, when the repair is made using a 7xxx weld filler alloy. In one embodiment, a repaired portion is substantially free of cracks when it contains at least about 5% fewer cracks than the amount of cracks a similarly prepared, repaired portion produced with an AA2319 weld filler alloy contains, when repairing a 7xxx alloy product. In another embodiment, the repaired portion contains at least about 10% fewer cracks than a similarly prepared, repaired portion produced with an AA2319 weld filler alloy. In yet another embodiment, the repaired portion contains at least about 15% fewer cracks than a similarly prepared, repaired portion produced with an AA2319 weld filler alloy. In some embodiments, the repaired portion may contain at least about 20% fewer, or at least about 30% fewer, or at least about 40% fewer, or at least about 50% fewer, or at least about 60% fewer, or at least about 70% fewer cracks than a similarly prepared repaired portion produced with an AA2319 weld filler alloy, when repairing a 7xxx alloy product.

A similarly prepared, repaired portion means that similar welding procedures are used to prepare a repaired portion, excluding the choice of the type of weld filler alloy. A crack is an internal or external surface opening and/or discontinuity. A crack generally affects the performance (e.g., shock resistance, wear resistance) of the original 7xxx alloy product. In one embodiment, the substantially crack-free repaired volume realizes a negligible (or no) adverse effect on (i) the structural performance, (ii) the surface texture and/or (iii) the color of the objects that contact the repaired volume.

In one embodiment, after a welding step, the cracks of the repaired portion of a 7xxx alloy product, such as a mold plate or mold block, are significantly smaller and fewer, when the repair is made using a 7xxx weld filler alloy. In one embodiment, the cracks of the repaired portion, produced with the 7xxx based filler alloy, are significantly smaller and fewer than that of a similarly prepared, repaired portion produced with an AA2319 weld filler alloy, when repairing a 7xxx alloy product. In another embodiment, the average of the crack lengths of the repaired portion is at least about 50% smaller than the average of the crack lengths of a similarly prepared, repaired portion produced with the AA2319 weld filler alloy, or any other weld filler alloy (e.g., AA4043, AA4145) used, when repairing a 7xxx alloy product. In other embodiments, the average of the crack lengths of the repaired portion is at least about 100% smaller, or at least about 200% smaller, or at least about 300% smaller, or at least about 400% smaller, or at least about 500% smaller, or at least about 600% smaller, or at least about 700% smaller, or at least about 800% smaller, or less, than the average of the crack lengths of a similarly prepared, repaired portion produced with an AA2319 weld filler alloy, when repairing a 7xxx alloy product.

In one embodiment, the average of the crack lengths of a repaired portion produced from a 7xxx weld filler alloy is not greater than about 19.0 mm (0.75 inch) when repairing a 7xxx alloy product. In other embodiments, the average of the crack lengths of a repaired portion produced from a 7xxx weld filler alloy is not greater than about 10.2 mm (0.4 inch), or not greater than about 8.9 mm (0.35 inch), or not greater than about 7.6 mm (0.3 inch), or not greater than about 6.4 mm (0.25 inch), or not greater than about 5.1 mm (0.2 inch), or not greater than about 3.8 mm (0.15 inch), or less, when repairing a 7xxx alloy product.

In one embodiment, the maximum of crack length of a repaired portion produced from a 7xxx weld filler alloy is at least about 200% smaller than the maximum crack length of a similarly prepared, repaired portion produced with an AA2319 weld filler alloy, when repairing a 7xxx alloy product. In other embodiments, the maximum crack length of a repaired portion produced from a 7xxx weld filler alloy is at least about 400% smaller, or at least about 600% smaller, or at least about 800% smaller, or at least about 1000% smaller, or at least about 1200% smaller, or at least about 1400% smaller, or at least about 1500% smaller, or less, than the maximum crack length of a similarly prepared, repaired portion produced with an AA2319 weld filler alloy, when repairing a 7xxx alloy product.

In one embodiment, the maximum crack length of a repaired portion produced from a 7xxx weld filler alloy is not greater than about 12.7 mm (0.5 inch) when repairing a 7xxx alloy product. In other embodiments, the maximum crack length of a repaired portion produced from a 7xxx weld filler alloy is not greater than about 10.2 mm (0.4 inch), or not greater than about 8.9 mm (0.35 inch), or not greater than about 7.6 mm (0.3 inch), or not greater than about 6.4 mm (0.25 inch), or not greater than about 5.1 mm (0.2 inch), or not greater than about 3.8 mm (0.15 inch), or less, when repairing a 7xxx alloy product. The number of cracks in a repaired portion, the average of the crack lengths of the repaired portion, and the maximum crack length of a repaired portion, may be measured using dye penetrant testing in accordance with ASTM E165, for example.

In one embodiment, the repaired portion and/or repaired product is at least as durable as a similarly prepared, repaired portion produced with an AA2319 weld filler alloy. For example, a repaired 7xxx mold plate repaired using the new 7xxx weld filler alloy disclosed herein may be at least as durable as a 7xxx repaired mold plate using AA2319, where the repaired mold plate using the new 7xxx weld filler alloy achieves at least the same amount (within acceptable statistical deviation) of acceptable injection mold-shots as that of the 7xxx repaired mold plate using AA2319. Acceptable injection mold-shots are those mold-shots in which the mold plate produces products having acceptable texture and color match. In one embodiment, the repaired portion is at least twice as durable as a similarly prepared, repaired portion produced with an AA2319 weld filler alloy.

In one embodiment, the repaired portion and/or repaired product has no pitting (e.g., open surface pores). Pitting means a discontinuity greater than 1 mm in diameter and/or depth. Pitting can result from contamination of the weld filler alloy, mold plate portion being repaired and/or shielding gas, with a hydrocarbonacious substance (e.g., grease) and/or moisture or poor welding techniques, which leave voids that have a detrimental impact on the surface to be textured in the instance of mold plates.

In one embodiment, the repaired portion is adherent. Adherent means that the weld-deposit, which is used to repair the damaged area of the 7xxx alloy product, reliably continues to adhere to the repaired portion in service (e.g., repeatable injection-molding shots), while continuing to retain/provide at least some of the appearance and/or functionally required properties discussed herein (e.g., wear resistance, texture, color match, shock resistance).

In one embodiment, the repaired portion may be integral with the 7xxx alloy product. An integral portion means that the repaired area has become integrated with the 7xxx alloy product by fusing and metallurgically bonding with it. In some embodiments, the integrated portion at least partially assists in restoring the appearance (e.g., color match, texture) and/or functionality (e.g., shock resistance, wear resistance) of 7xxx alloy product that is repaired.

In one embodiment, the repaired portion and/or repaired 7xxx product is wear resistant. Wear resistant means that the combination of hardness, toughness and ductility of the weld deposit, which is used to repair the damaged area of the 7xxx alloy product, is sufficient to withstand repeated and numerous injection-molding shots in service. For different injection molding applications (e.g. different polymers), the hardness of this weld-deposit may be chosen so it is compatible with the hardness of the original portion of the 7xxx alloy product. In some embodiments, the repaired portion, and sometime the whole repaired 7xxx product, may be artificially aged (e.g., to an appropriate temper) after the repairing step to facilitate production of a repaired portion, which has a hardness and/or wear resistance that resembles that of the original portion. In one embodiment, each of the repaired portion and/or repaired product has a hardness that is at least equivalent to that of a repaired portion produced from AA2319 weld filler alloy.

In one embodiment, each of the repaired portion and/or repaired product is resistant to thermal shock. Thermal shock resistant means that the weld-deposit, which is used to repair the 7xxx alloy product, and the original portion, can withstand repeated and numerous extreme changes in temperature without cracking and/or to a degree that adversely affects the performance of the repaired portion and/or original portion.

In one embodiment, each of the repaired portion and/or repaired product is impact shock resistant. Impact shock resistant means that the weld-deposit, which is used to repair the 7xxx alloy product, and the original portion, can withstand repeated and numerous mechanical-type impacts without cracking and/or to a degree that adversely affects the performance of the repaired portion and/or original portion.

The weld filler alloy generally includes zinc and in the range of 6.0 to 11.0 wt. %. In one embodiment, the 7xxx weld filler alloy includes at least about 6.5 wt. % zinc. In some embodiments, the weld filler alloy includes at least about 6.6 wt. % Zn, or at least about 6.7 wt. % Zn, or at least about 6.8 wt. % Zn, or at least about 6.9 wt. % Zn, or at least about 7.0 wt. % Zn. In one embodiment, the 7xxx weld filler alloy includes not greater than about 9.0 wt. % Zn. In some embodiments, the 7xxx weld filler alloy includes not greater than about 8.5 wt. % Zn.

The weld filler alloy generally includes magnesium and in the range of from about 1.0 wt. % to about 3.1 wt. %. In one embodiment, the weld filler alloy includes at least about 1.3 wt. % Mg. In other embodiments, the weld filler alloy includes at least about 1.4 wt. % Mg, or at least about 1.5 wt. % Mg, or at least about 1.6 wt. % Mg. In one embodiment, the weld filler alloy includes not greater than about 2.8 wt. % Mg. In other embodiments, the weld filler alloy includes not greater than about 2.5 wt. % Mg, or not greater than about 2.4 wt. % Mg, or not greater than about 2.3 wt. % Mg, or not greater than about 2.2 wt. % Mg, or not greater than about 2.1 wt. % Mg, or not greater than about 2.0 wt. % Mg, or not greater than about 1.95 wt. % Mg.

The weld filler alloy generally includes at least about 0.5 wt. % copper. The alloy generally includes copper below the solubility threshold of the alloy for copper. In one embodiment, the alloy includes at least about 0.75 wt. % Cu. In other embodiments, the alloy includes at least about 1.0 wt. % Cu, or at least about 1.2 wt. % Cu, or at least about 1.3 wt. % Cu, or at least about 1.4 wt. % Cu, or at least about 1.5 wt. % Cu, or at least about 1.6 wt. % Cu. In one embodiment, the alloy includes not greater than about 2.5 wt. % Cu. In other embodiments, the alloy includes not greater than about 2.4 wt. % Cu, or not greater than about 2.3 wt. % Cu, or not greater than about 2.2 wt. % Cu, or not greater than about 2.1 wt. % Cu, or not greater than about 2.0 wt. % Cu, or not greater than about 1.95 wt. % Cu.

In one embodiment, the weld filler alloy is AA7085. Some embodiments of AA7085 useful in accordance with the instant disclosure are disclosed below.

TABLE 1
Embodiments of 7085 Weld Filler Alloys

| | Zn | Mg | Cu | Zr | Al |
|---|---|---|---|---|---|
| 7085-V1 | 7-9.5 | 1.3-1.68 | 1.2-1.9 | 0-0.40 | Balance |
| 7085-V2 | 7-8.5 | 1.4-1.68 | 1.3-1.8 | 0.05-0.25 | Balance |
| 7085-V3 | 7-8.0 | 1.5-1.68 | 1.4-1.7 | 0.08-0.12 | Balance |

7085-V1 comprises (and in some instances consists essentially of) from about 7.0 wt. % Zn to about 9.5 wt. % Zn, from about 1.3 wt. % Mg to about 1.68 wt. % Mg, from about 1.2 wt. % Cu to about 1.9 wt. % Cu, and from about 0 wt. % Zr to about 0.40 wt. % Zr, the balance essentially aluminum and incidental elements and impurities.

7085-V2 comprises (and in some instances consists essentially of) from about 7.0 wt. % Zn to about 8.5 wt. % Zn, from about 1.4 wt. % Mg to about 1.68 wt. % Mg, from about 1.3 wt. % Cu to about 1.8 wt. % Cu, and from about 0.05 wt. % Zr to about 0.25 wt. % Zr, the balance essentially aluminum and incidental elements and impurities.

7085-V3 comprises (and in some instances consists essentially of) from about 7.0 wt. % Zn to about 8.0 wt. % Zn, from about 1.5 wt. % Mg to about 1.68 wt. % Mg, from about 1.4 wt. % Cu to about 1.7 wt. % Cu, and from about 0.08 wt. % Zr to about 0.12 wt. % Zr, the balance essentially aluminum and incidental elements and impurities.

The alloys of the present disclosure generally include the stated alloying ingredients, the balance being aluminum, optional grain structure control elements, optional incidental elements and impurities.

As used herein, “grain structure control element” means elements or compounds that are deliberate alloying additions with the goal of forming second phase particles, usually in the solid state, to control solid state grain structure changes during thermal processes, such as recovery and recrystallization. Examples of grain structure control elements include Zr, Sc, V, Cr, Mn, and Hf, to name a few.

The amount of grain structure control material utilized in an alloy is generally dependent on the type of material utilized for grain structure control and the alloy production process. When zirconium (Zr) is included in the alloy, it may be included in an amount up to about 0.4 wt. %, or up to about 0.3 wt. %, or up to about 0.2 wt. %. In some embodiments, Zr is included in the alloy in an amount of from about 0.05 wt. % to about 0.15 wt. % (e.g., from about 0.08 wt. % to about 0.13 wt. %). Scandium (Sc), vanadium (V), chromium (Cr), Manganese (Mn) and/or hafnium (Hf) may be included in the alloy as a substitute (in whole or in part) for Zr, and thus may be included in the alloy in the same or similar amounts as Zr. In some embodiments, no grain structure control elements are used, such as when there is no inherent need to control, for example, recrystallization.

As used herein, “incidental elements” means those elements or materials that may optionally be added to the alloy to assist in the production of the alloy. Examples of incidental elements include casting aids, such as grain refiners and deoxidizers.

Grain refiners are inoculants or nuclei to seed new grains during solidification of the alloy. An example of a grain refiner is a 9.5 mm (⅜ inch) rod comprising 96% aluminum, 3% titanium (Ti) and 1% boron (B), where virtually all boron is present as finely dispersed TiB₂ particles. During casting, the grain refining rod is fed in-line into the molten alloy flowing into the casting pit at a controlled rate. The amount of grain refiner included in the alloy is generally dependent on the type of material utilized for grain refining and the alloy production process. Examples of grain refiners include Ti combined with B (e.g., TiB₂) or carbon (TiC), although other grain refiners, such as Al—Ti master alloys may be utilized. Generally, grain refiners (e.g., carbon or boron) may be added to the alloy in an amount of ranging from 0.0003 wt. % to 0.03 wt. %, depending on the desired as-cast grain size. In addition, Ti may be separately added to the alloy in an amount up to 0.03 wt. % to increase the effectiveness of grain refiner. When Ti is included in the alloy, it is generally present in an amount of up to about 0.10 or 0.20 wt. %.

Some alloying elements, generally referred to herein as deoxidizers (irrespective of whether the actually deoxidize), may be added to the alloy during casting to reduce or restrict (and is some instances eliminate) cracking of the ingot resulting from, for example, oxide fold, pit and oxide patches. Examples of deoxidizers include Ca, Sr, and Be. When calcium (Ca) is included in the alloy, it is generally present in an amount of up to about 0.05 wt. %, or up to about 0.03 wt. %. In some embodiments, Ca is included in the alloy in an amount of from about 0.001 wt. % to about 0.03 wt. %, or from about 0.001 wt. % to about 0.05 wt. %, or from about 0.001 wt. % to about 0.008 wt. % (or from about 10 ppm to about 80 ppm). Strontium (Sr) may be included in the alloy as a substitute for Ca (in whole or in part), and thus may be included in the alloy in the same or similar amounts as Ca. Traditionally, beryllium (Be) additions have helped to reduce the tendency of ingot cracking, though for environmental, health and safety reasons, some embodiments of the alloy are substantially Be-free. When Be is included in the alloy, it is generally present in an amount of up to about 20 ppm.

Incidental elements may be present in minor amounts, or may be present in significant amounts, and may add desirable or other characteristics on their own without departing from the alloy described herein, so long as the alloy retains the desirable characteristics described herein. It is to be understood, however, that the scope of this disclosure should not/cannot be avoided through the mere addition of an element or elements in quantities that would not otherwise impact on the combinations of properties desired and attained herein.

As used herein, impurities are those materials that may be present in the alloy in minor amounts due to, for example, the inherent properties of aluminum and/or leaching from contact with manufacturing equipment. Iron (Fe) and silicon (Si) are examples of impurities generally present in aluminum alloys. The Fe content of the alloy should generally not exceed about 0.25 wt. %. In some embodiments, the Fe content of the alloy is not greater than about 0.15 wt. %, or not greater than about 0.10 wt. %, or not greater than about 0.08 wt. %, or not greater than about 0.05 wt. % or about 0.04 wt. %. Likewise, the Si content of the alloy should generally not exceed about 0.25 wt. %, and is generally less than the Fe content. In some embodiments, the Si content of the alloy is not greater than about 0.12 wt. %, or not greater than about 0.10 wt. %, or not greater than about 0.06 wt. %, or not greater than about 0.03 wt. % or about 0.02 wt. %.

Except where stated otherwise, the expression “up to” when referring to the amount of an element means that that elemental composition is optional or incidental and includes a zero amount of that particular compositional component. Unless stated otherwise, all compositional percentages are in weight percent (wt. %).

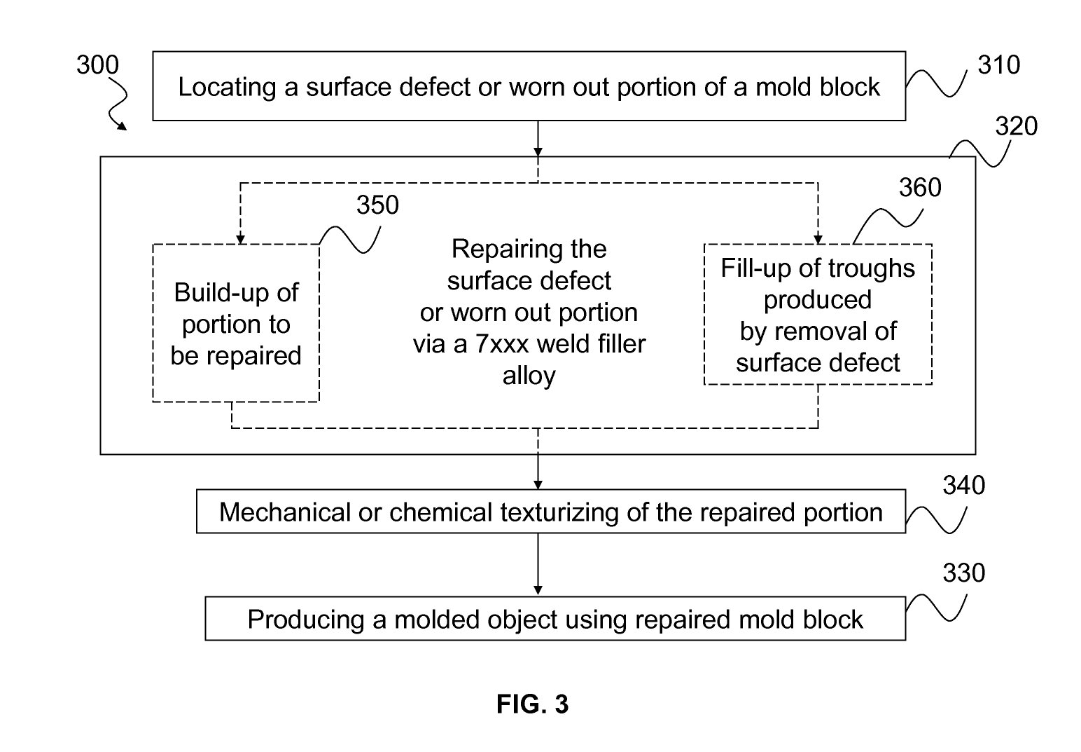

One embodiment useful in accordance with the present disclosure is illustrated in FIG. 3. The method (300) includes locating a surface defect or worn out portion of a mold block (310), and repairing the surface defect or worn out portion via a 7xxx weld filler alloy (320). Prior to the repairing step (320), the surface defect (or worn out portion) has a first volume, which is at least partially surrounded by an original volume. The mold block includes the original volume, and is made of a wrought 7xxx aluminum alloy. The repairing step (320) may include fusion welding the 7xxx weld filler alloy to at least a portion of the non-defective volume to produce a repaired volume. In another embodiment, the repairing step (320) includes patch welding. Patch welding is welding in a localized area for the purpose of repair of a damages area (e.g., crack(s), worn down areas), and which has the appearance of a patch.

In one embodiment, the repairing step (320) includes repairing the surface defect or worn out portion by a build-up step (350). For example, the repairing step (320) includes building-up (350) the repaired portion to a height that is higher than that of the outer surface of the 7xxx alloy product. This may be useful, for example, for rebuilding worn out portions of the mold plate or imparting new geometric features to improve the control over the flow of the injected plastic or add new functional features, in order to form the injected parts into the desired final shape.

In another embodiment, the repairing step (320) includes filling troughs by removing the surface defects (360). For example, the repairing step (320) includes trough filling (360) the defective area to its original shape by depositing a 7xxx weld deposit on top and adjacent of the trough or surface defect. This may be useful, for example, for repairing damaged portions of the mold plate to improve the control over the flow of the injected plastic in order to produce injected plastic parts with the desired final shape similar to injected plastic parts produced with an undamaged mold plate.

After the repairing step (320), whether by build-up (350) or fill-up (360), the repaired volume may include the first volume of the surface defect and at least a portion of the original mold plate adjacent to the original defective volume diluted into and mixed with the molten filler alloy that filled and replaced the defective volume into the repaired one.

In one embodiment, after the repairing step (320), the repaired portion of the 7xxx alloy product may be optionally texturized in a texturizing step (340). In some instances, the texturizing step (340) may be accomplished by mechanical denting, chemical etching or a combination of the two. In some embodiments, texturizing a repaired mold plate may improve injection molding productivity with the mold plate having a longer lifetime (e.g., can be used longer, can last longer).

In one embodiment, the repaired volume (with or without texturizing) is substantially crack-free. In another embodiment, after the repairing step (320), with or without texturizing, an object is produced (330) via the repaired 7xxx alloy product. In one embodiment, an outer surface of the object produced via the repaired 7xxx alloy product has substantially the same color on its outer surface. In another embodiment, after the repairing step (320), with or without texturizing, an outer surface of the object produced via the repaired 7xxx alloy product has substantially the same texture on its outer surface.

In one embodiment, the average height of the repaired portion may be at least about 6.4 mm (0.25 inch) higher than that of the surrounding outer surface of the 7xxx alloy product. In other embodiments, the average height of the repaired portion is at least about 12.7 mm (0.5 inch) higher, or at least about 25.4 mm (1.0 inch) higher, or at least about 38.1 mm (1.5 inches) higher, or at least about 50.8 mm (2.0 inches) higher, or at least about 63.5 mm (2.5 inches) higher, or at least about 76.2 mm (3.0 inches) higher, or at least about 88.9 mm (3.5 inches) higher, or at least about 101.6 mm (4.0 inches) higher, or more, than that of the surrounding outer surface of the 7xxx alloy product. The strength of such built-up repaired portions may be substantially higher than that of similarly prepared built-up repaired portions produced from AA2319 weld filler alloys, when repairing a 7xxx alloy product.

In one embodiment, the ultimate tensile strength of such built-up repaired portions is at least about 10% higher than that of similarly prepared built-up repaired portions produced from AA2319 weld filler alloys, when repairing a 7xxx alloy product. In other embodiments, the ultimate tensile strength of such built-up repaired portions is at least about 15% higher, or at least about 20% higher, or at least about 25% higher, or at least about 30% higher, or at least about 35% higher, or more, than that of similarly prepared built-up repaired portions produced from AA2319 weld filler alloys, when repairing a 7xxx alloy product. In one embodiment, a built up repaired portion achieves an ultimate tensile strength of at least about 170 MPa. In other embodiments, a built-up repaired portion achieves an ultimate tensile strength of at least about 175 MPa, or at least about 180 MPa, or at least about 185 MPa, or at least about 190 MPa, or at least about 195 MPa, or at least about 200 MPa, or at least about 205 MPa, or more. These built-up repaired portions produced with the 7xxx weld filler alloy may also achieve the cracking performance described above.

The following examples demonstrate the efficacy of the presently disclosed 7xxx weld filler alloys in restoring and repairing 7xxx series mold plates. In these examples, weld deposits produced from AA7085 and AA2319 weld filler alloys are used to restore and repair AA7085 mold plates.

### Example 1

### Weld Repair of 7085 Mold Plate with AA2319 and AA7085 Weld Filler Alloys

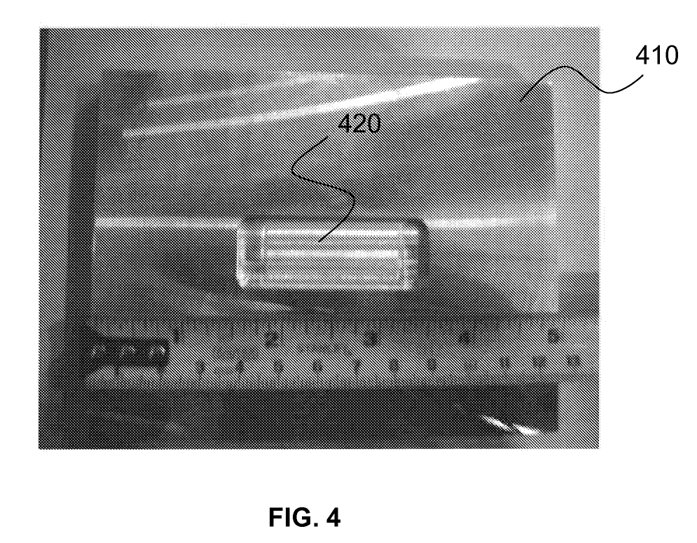

To test the efficacy of the presently disclosed weld filler alloys, a discontinuity is produced in two mold plates produced from AA7085. As illustrated in FIG. 4, the mold plate is a half-inch thick aluminum alloy plate 410 with a surface discontinuity 420. The discontinuity 420 is produced by machining to evaluate the effect of the new AA7085 weld filler alloys in comparison to the AA2319 weld filler alloy. The discontinuity 420 is an aperture having a depth of about 2.5 mm (0.1 inch), length of about 50.8 mm (2 inches), and width of about 19.1 mm (0.75 inch).

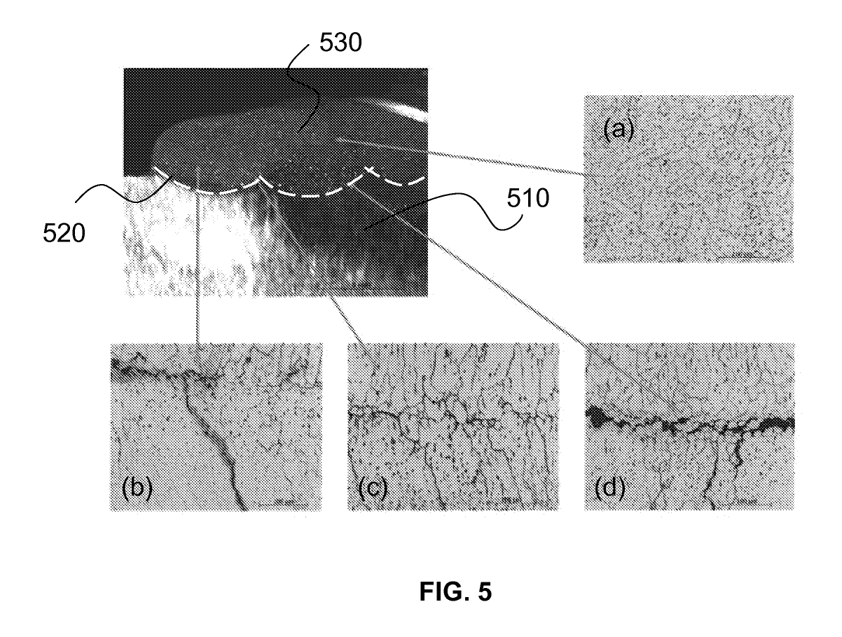

As illustrated in FIG. 5, a discontinuity 520 in a first AA7085 mold plate 510 is repaired using an AA2319 weld filler alloy, an industry standard for weld filler alloys, to deposit three repair welds 530. Gas tungsten arc welding is used to complete the repair process. The AA2319 repaired welds 530 is examined using a microscope as shown by cross-sectional macro (15×) and micro (200×) views of the AA2319 weld deposit 530. Each weld deposit 530 includes a plurality of weld structures such as fusion lines as best illustrated by the dashed lines. Although the weld deposit 530 appears sound and no surface cracks are observed in the body (a) of the weld, cracks are present at the fusion lines of each of the three weld deposits and the mold plate. In other words, cracks are visible at the fusion lines (b), (c), (d) as best illustrated by the dashed lines between the weld deposit 530 and the mold plate 510. Furthermore, some of the cracks at the fusion lines propagate along the grain boundaries of the mold plate 510 (b), (d).

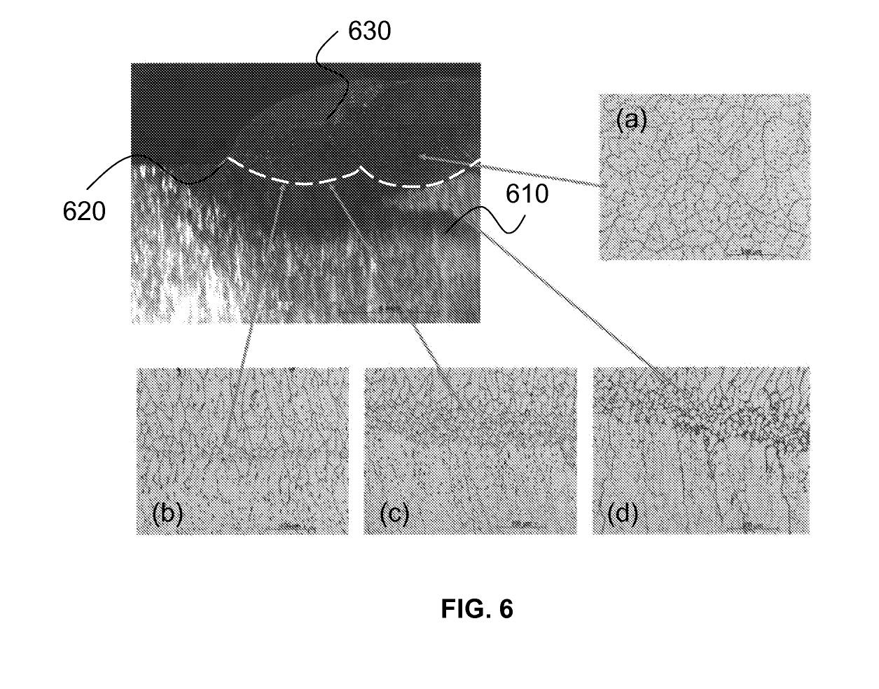

As illustrated in FIG. 6, a discontinuity 620 in a second AA7085 mold plate 610 is repaired using the new AA7085 weld filler alloy to deposit the welds 630 onto the mold plate 610. Gas tungsten arc welding is used to complete the repairs. The AA7085 repaired welds 630 is examined using a microscope as shown by cross-sectional macro (15×) and micro (200×) views of the AA7085 weld deposit 630. The weld deposit 630 is substantially sound and no surface cracks are observed in the body (a) of the weld. The fusion lines are crack free at interfaces (b), (c), (d). In other words, no cracks are observed in the interfaces (b), (c), (d) between the weld deposit 630 and the mold plate 610.

### Example 2

### Weld Repair of 7085 Mold Plate with TiB₂ Modified AA7085 Weld Filler Alloy

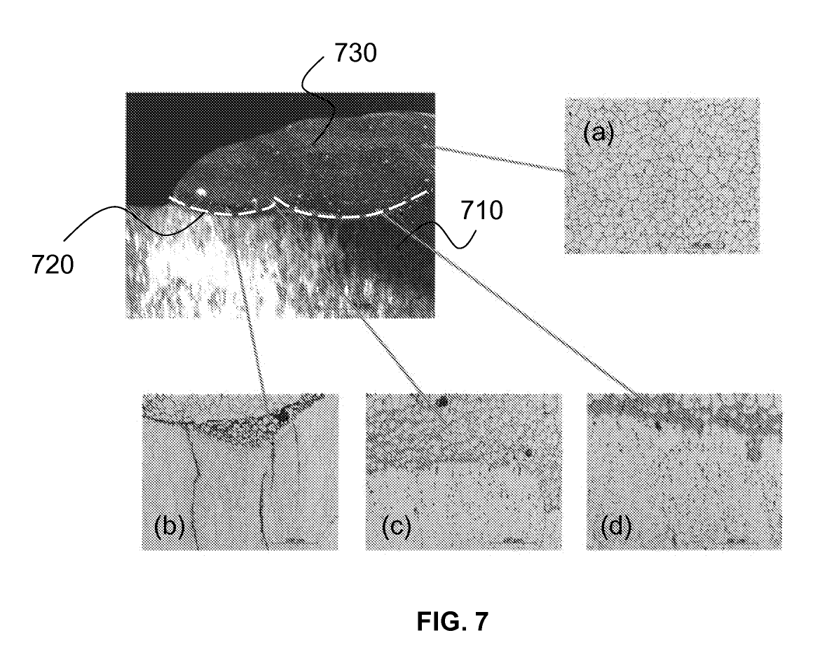

To further test the efficacy of the presently disclosed weld filler alloys, a discontinuity 720, as illustrated in FIG. 7, is produced in a mold plate 710 produced from AA7085. The discontinuity 720 is repaired with AA7085 containing about 0.06 wt. % Ti and about 0.02 wt. % B. The weld repair deposit 730 produced with AA7085-TiB₂ is examined using a microscope as shown by cross-sectional macro (15×) and micro (200×) views of the AA7085-TiB₂ weld deposit 730. The weld deposit 730 is substantially sound and no surface cracks are observed in the body (a) of the weld. Cracks are visible at the fusion line (b), minimally observed at (d) and substantially none existent at (c). In other words, although cracks are observed at the fusion lines of the weld deposit 730, there is still a noticeable reduction in cracking with this AA7085 based filler alloy compared to the cracking developed with AA2319 filler alloy (FIG. 5).

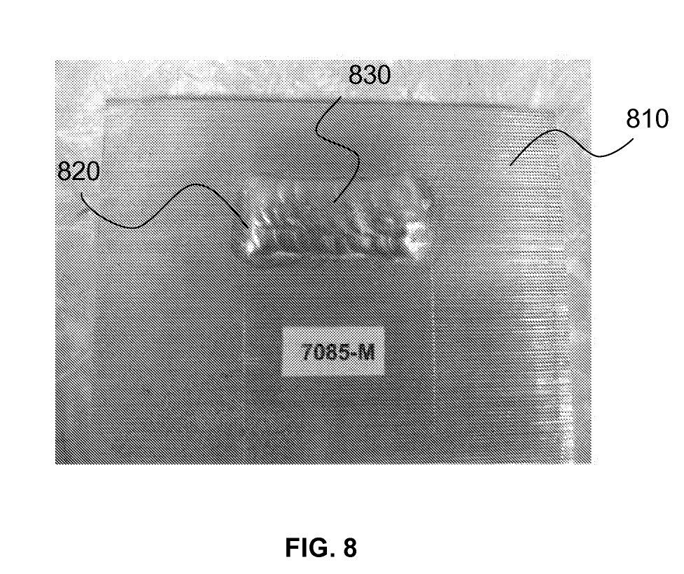

FIG. 8 is a top-down view of a repaired aluminum alloy mold plate 810 after filling the discontinuity 820 with the AA7085-TiB₂ weld filler alloy 830.

### Example 3

### Weld Deposits of 7085 Mold Plate with AA7085 and AA2319 Weld Filler Alloys

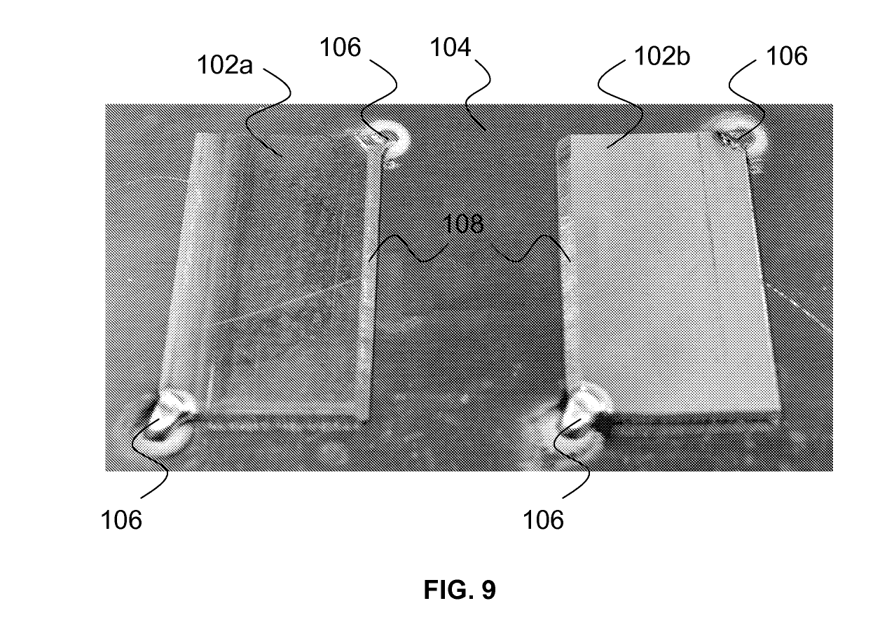

FIG. 9 shows run-in and run-off tabs 102a, 102b attached to a mold plate 104 using tack-weld joints 106. The run-in and run-off tabs 102a, 102b and the mold plate 104 are about 6.4 mm (0.25 inch) thick and made from AA7085. The edges 108 of the run-in and run-off tabs 102a, 102b are tapered to facilitate a weld deposition process, sometimes also referred to as plate restoration or weld build-up process. A run-in tab is the side where a welding arc can make an initial deposition, continue across the surface of the mold plate (as necessary), and terminate at a run-off tab.

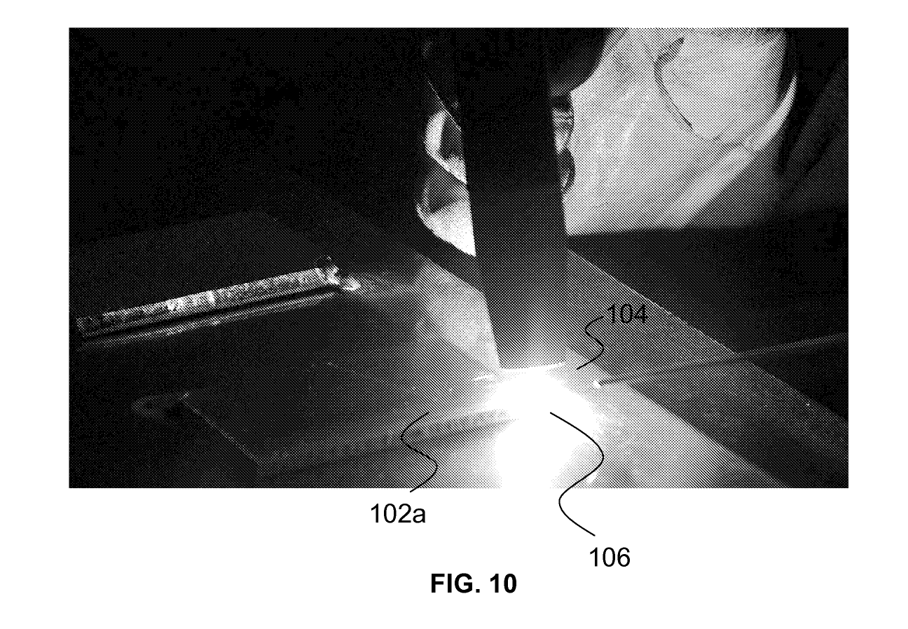

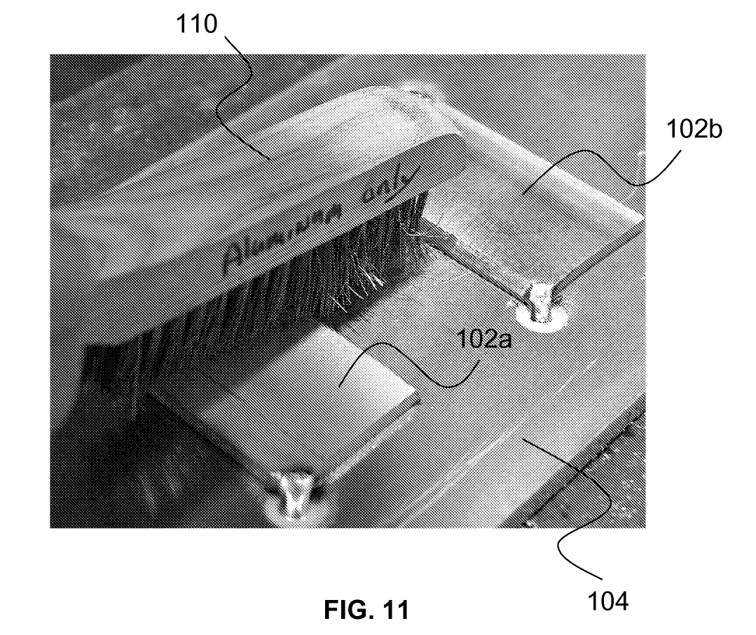

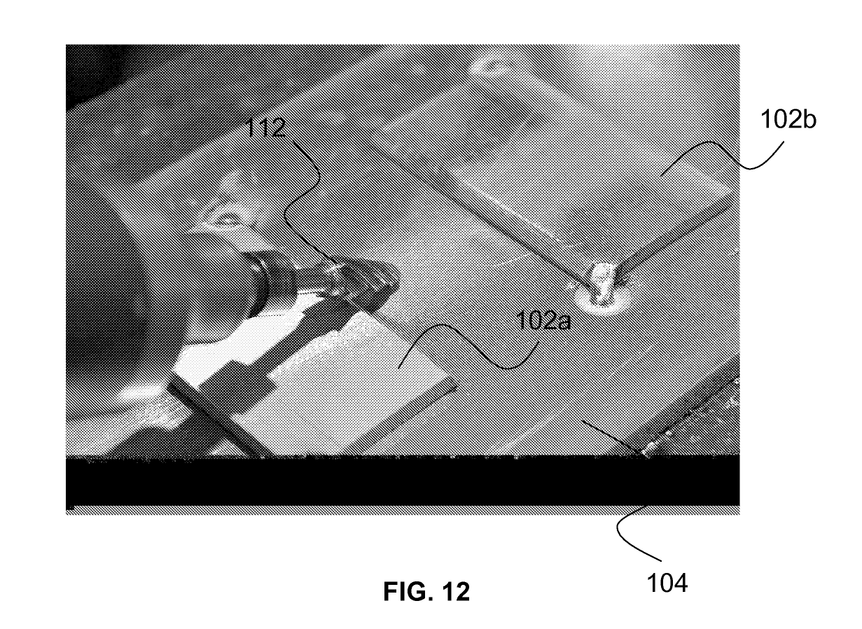

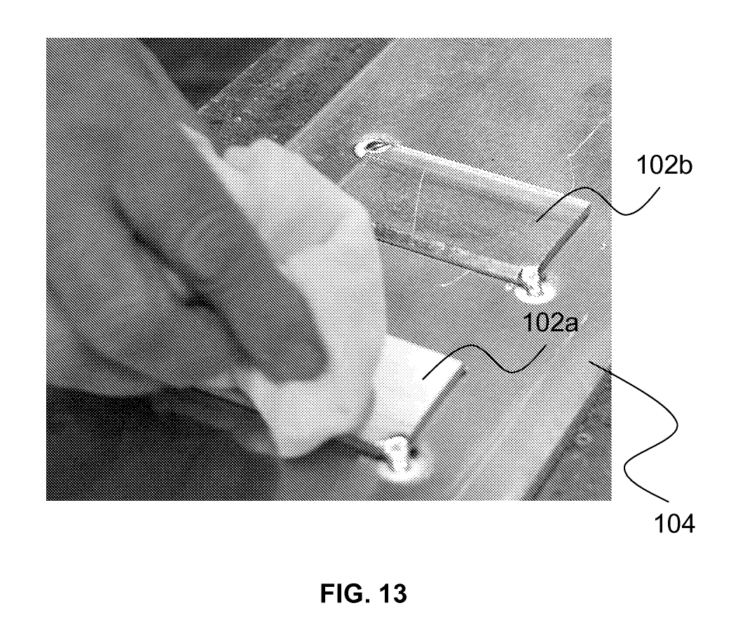

Referring now to FIGS. 10-13, prior to the weld deposition process, several pre-welding steps are taken in preparing the sample including forming the shape and size of the run-in and run-off tabs 102a, 102b by machining or grinding, tack-welding the run-in and run-off tabs 102a, 102b to the mold plate 104 (FIG. 10), solvent cleaning and drying (FIG. 13), abrading the areas to be weld deposited with a stainless steel brush (FIG. 11) or grinding with hand-held router (FIG. 12), and solvent cleaning and drying, again, the areas in preparation for the weld deposition process (FIG. 13).

FIG. 10 shows the corners of the run-in and run-off tabs 102a, 102b being attached to a mold plate 104 via tack-weld joints 106. The size and shape of the run-in and run-off tabs 102a, 102b, including tapered edges 108, are pre-fabricated by machining or grinding. FIG. 11 shows the run-in and run-off tabs 102a, 102b, including portions of the mold plate 104 in between, being abraded or brushed by a stainless steel brush 110 in preparation for forming weld deposits with the manual GTAW process, operating in the AC (alternating current) mode. FIG. 12 shows the run-in and run-off tabs 102a, 102b, including portions of the mold plate 104 in between, being grinded by a hand-held router 112 for removal of any potential surface oxides in preparation for forming weld deposits in the alternate deeper arc penetrating DC (direct current) mode. FIG. 13 shows the run-in and run-off tabs 102a, 102b, including portions of the mold plate 104 in between, being solvent cleaned and dried in preparation for forming weld deposits in both AC and DC modes.

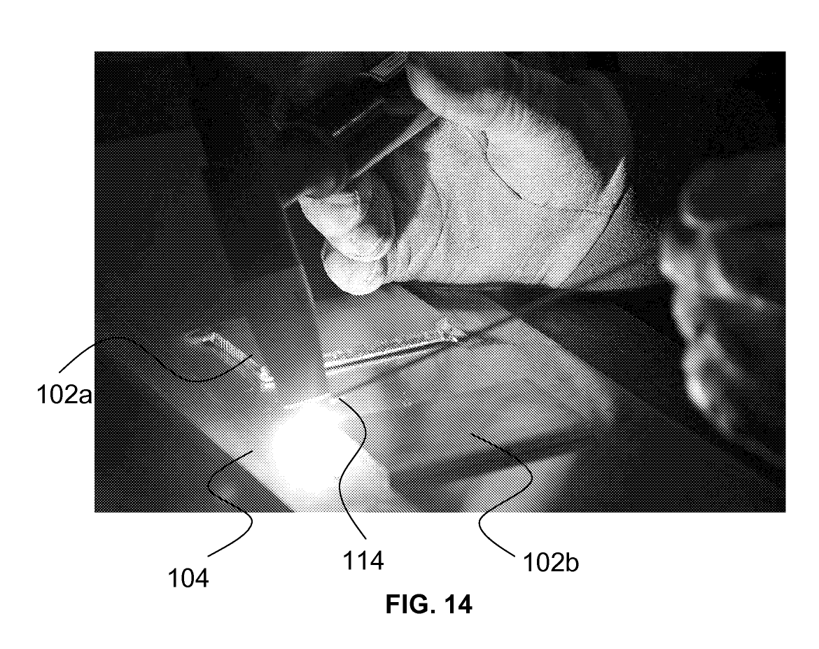

FIG. 14 shows a filler rod 114 being fed into the arc, while welding the run-in tab 102a and top of the mold plate 104, using the manual GTAW process. The process can be finished by completing the weld on the run-off tab 102b.

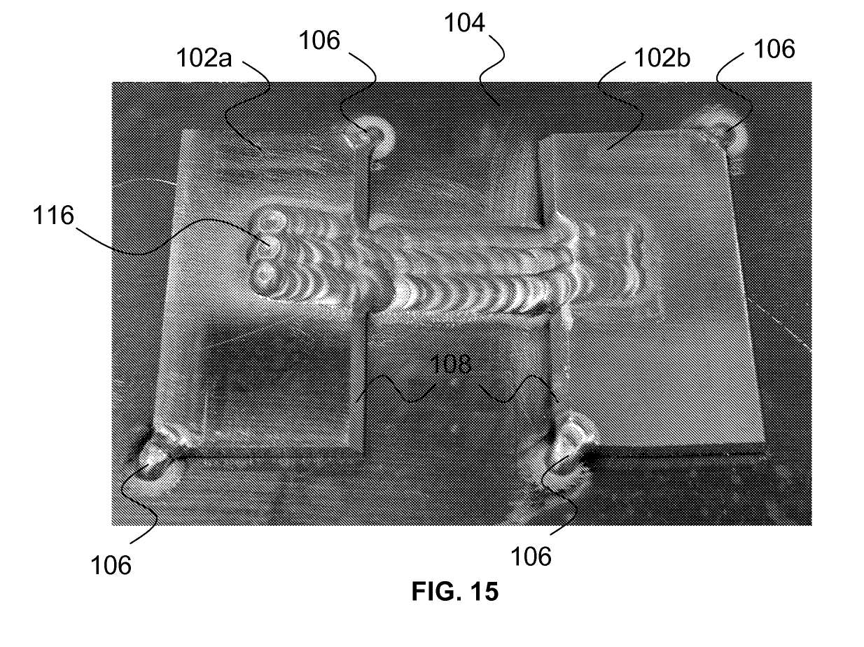

FIG. 15 shows three lines of weld deposits 116 formed across portions of the run-in and run-off tabs 102a, 102b and the mold plate 104, the weld deposits 116 beginning from a run-in tab 102a, continuing across portions of the mold plate 104, and terminating at a run-off tab 102b.

The process conditions for manual GTAW deposition using AA7085 filler wire/rod and AA2319 weld filler wire/rod as the filler material 114 and eventual formation of the weld deposits 116 are summarized in Table 2. The size of the mold plate 104 is about 310 mm (12 inch) in length, about 310 mm (12 inch) in width, and about 191 mm (7.5 inch) in height. The size and shape of the mold plates 104 is adequate to function as a suitable heat sink for the weld deposition trial runs of Table 2.

TABLE 2
Process Conditions for Manual GTAW

| Parameters | Trial 1 | Trial 2 | Trial 3 | Trial 4 |
|---|---|---|---|---|
| Filler Alloy | AA7085 | AA2319 | AA7085 | AA2319 |
| Current/ | AC | AC | DC/Electrode | DC/Electrode |
| Polarity | | | Negative | Negative |
| Amperage | 100-350 | 100-350 | 100-350 | 100-350 |
| (A) | | | | |
| Voltage (V) | 17-26 | 17-26 | 17-26 | 17-26 |

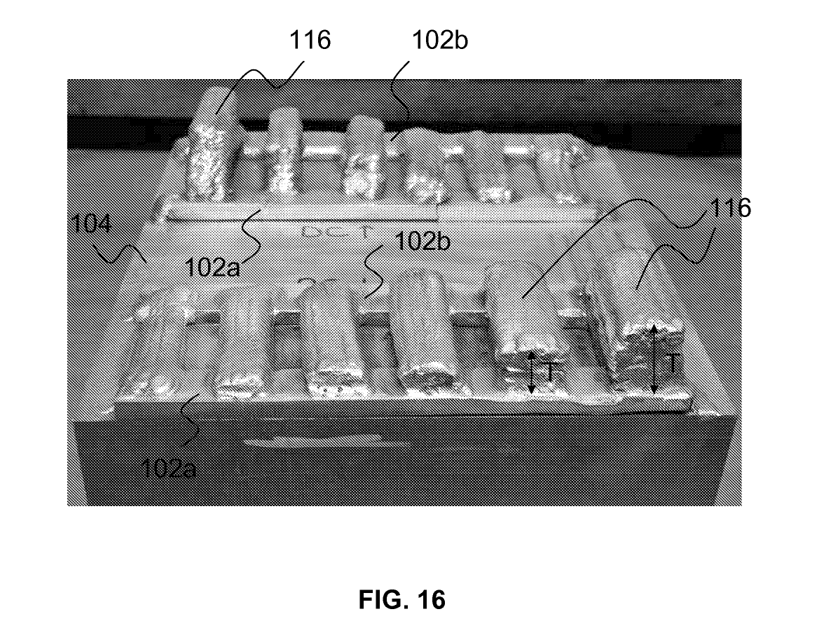

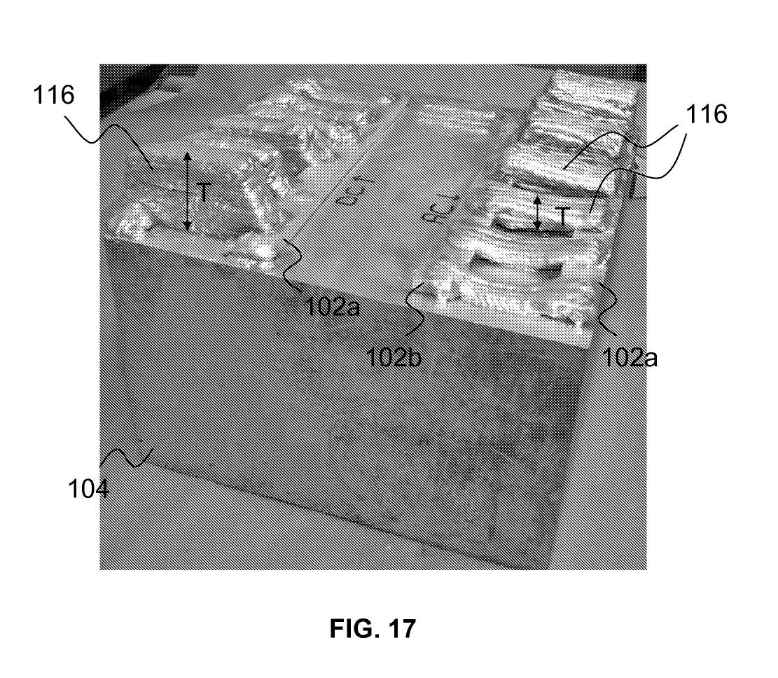

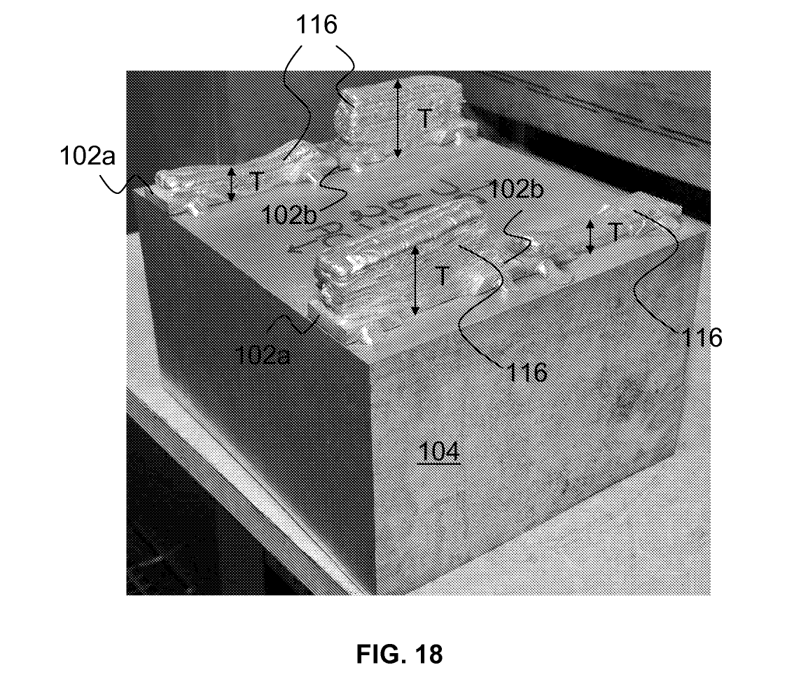

FIGS. 16-18 are top and side perspective views of weld deposits 116 having a variety of thicknesses (T) ranging from about 13 mm (0.5 inch) to about 51 mm (2 inch). The weld deposits 116 of FIGS. 16-17 correspond to Trials 1 and 3 (AA7085, AC and DC on opposite sides) while the weld deposits 116 of FIG. 18 correspond to Trials 2 and 4 (AA2319, AC and DC on opposite sides). The thicknesses or heights of these weld deposits 116 are dependent on the number of welding passes made. In general, the greater the number of welding passes, the thicker or higher the weld deposit 116.

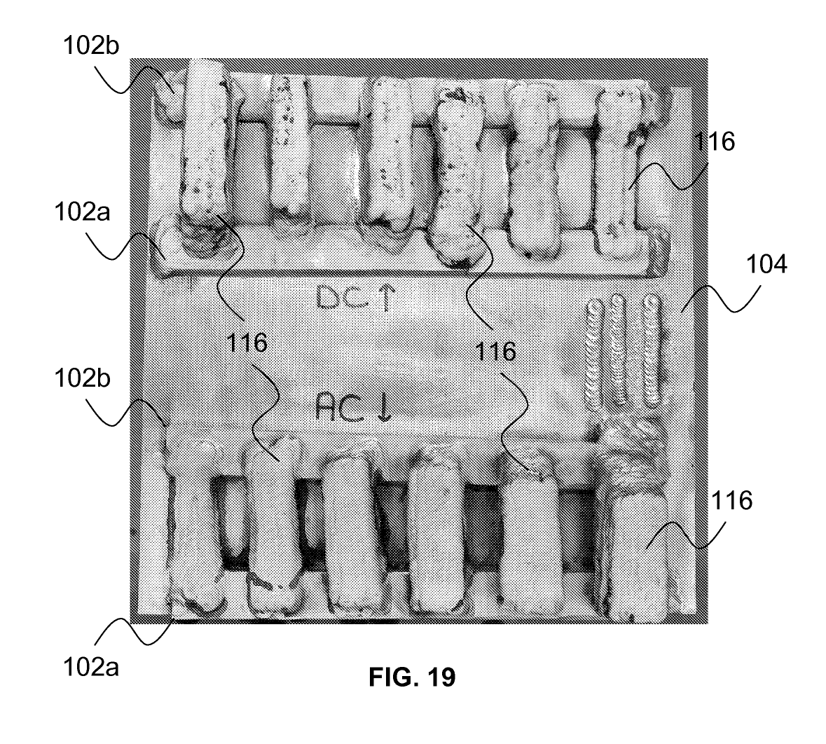

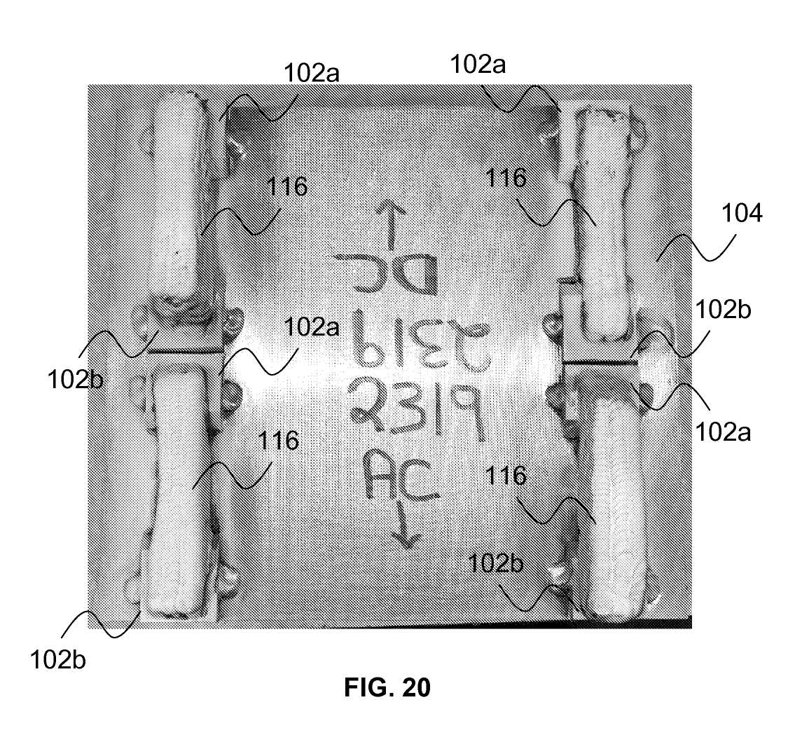

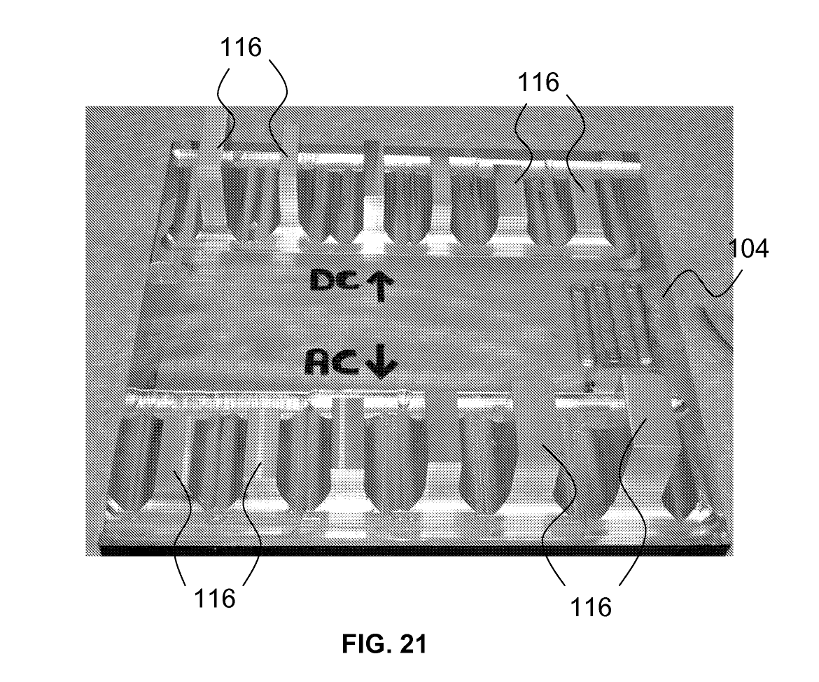

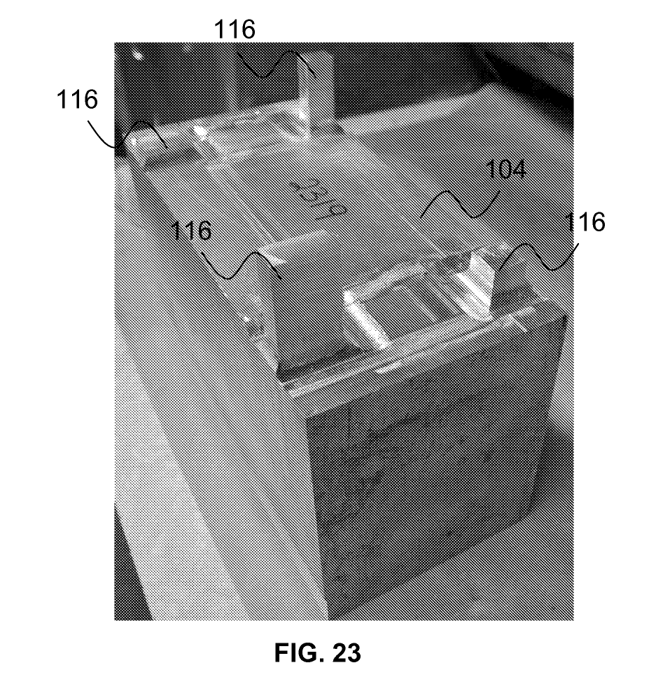

FIGS. 19-20 are top perspective views of the weld deposits 116 of FIGS. 16-18 being inspected with the dye-penetrant test for open surface discontinuities (e.g., cracks, pores, other defects). FIGS. 21-23 are top and side perspective views of the weld deposits 116 of FIGS. 16-18 having substantially planar surfaces after machining portions of the weld deposits 116 such that the weld deposits 116 and the mold plate 104 are substantially planar. The run-in and run-off tabs 102a, 102b are also removed by the machining step.

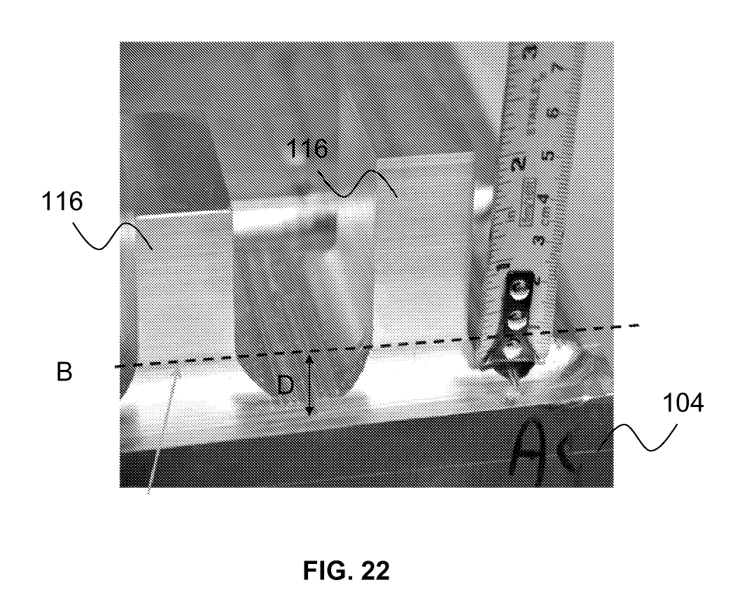

The mold plate 104 (FIG. 22) is machined or grinded to facilitate visual inspection of cracking localized at the base (B) of the weld deposits 116. In FIG. 22, a depth (D) of at least about 10 mm (0.4 inch) is obtained at the base (B), at which the fusion lines between the weld build ups 116 and the mold plate 104 are approximately located. The base (B) defines the boundary between the mold plate 104 and the weld deposit 116. By machining into portions of the mold plate 104, the base (B) is exposed to facilitate visual and dye-penetrant inspections.

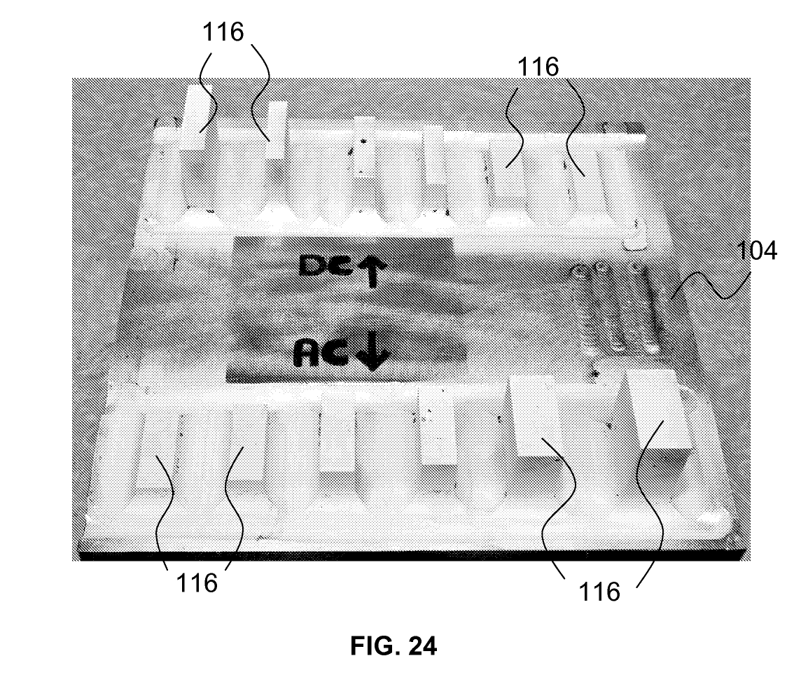

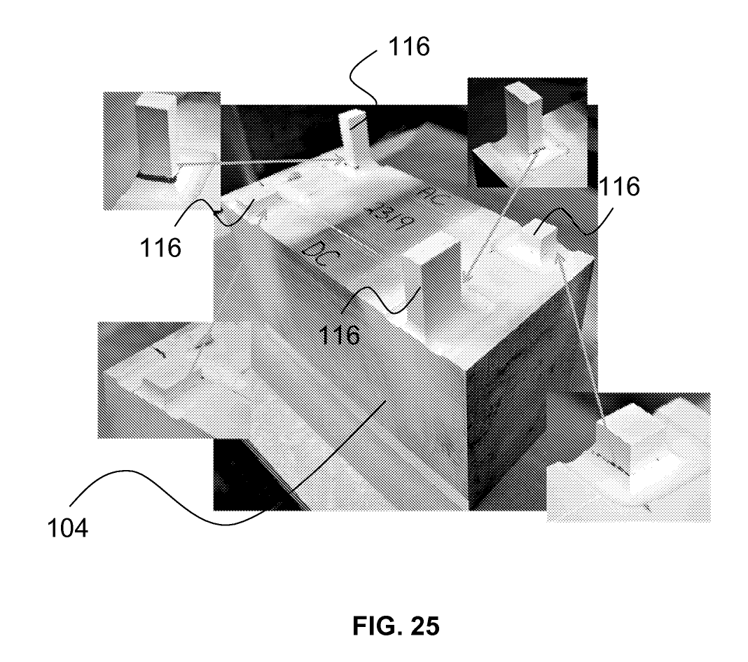

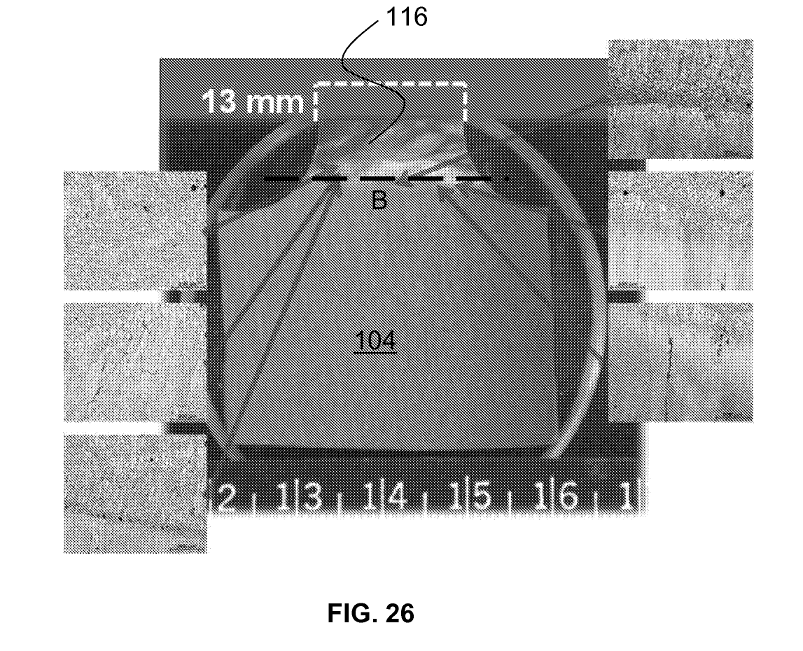

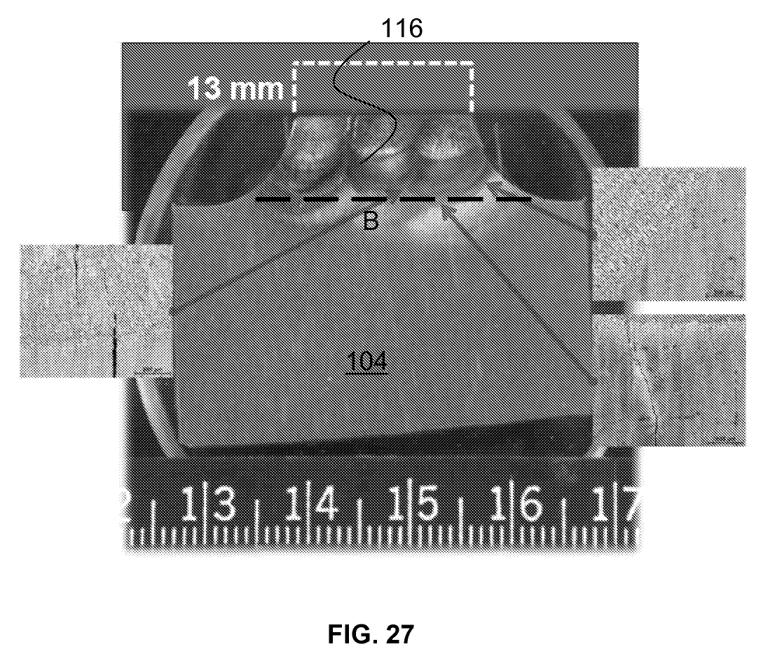

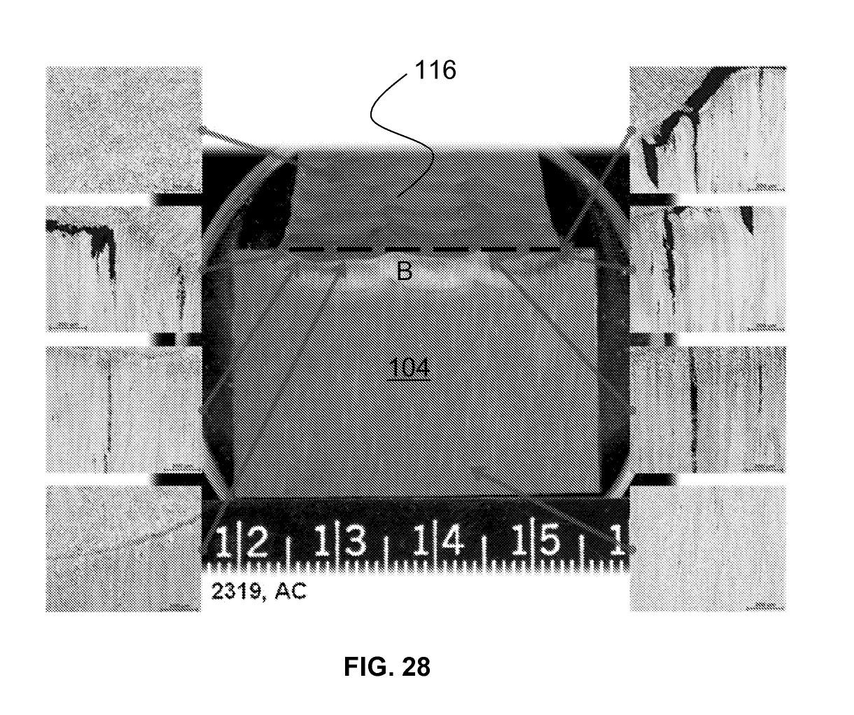

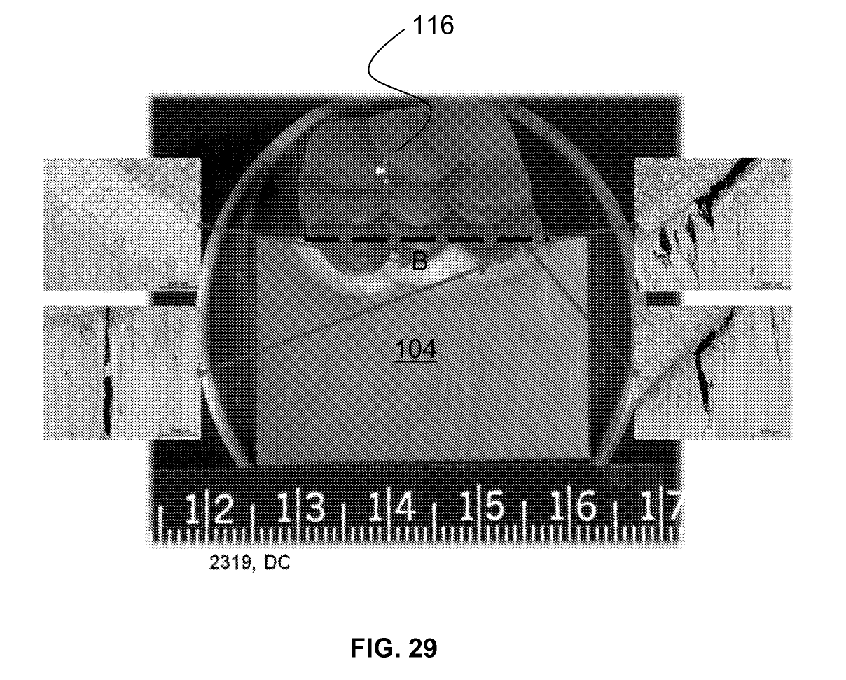

FIGS. 24-25 are top perspective views of the weld deposits 116 of FIGS. 21-23 being inspected with the dye-penetrant test for open surface discontinuities (e.g., cracks, pores, other defects). FIGS. 26-29 are cross-sectional macro/micrographs (15×/100×) through the weld deposits 116, where FIGS. 26-27 correspond to Trials 1 and 3, respectively, and FIGS. 28-29 correspond to Trials 2 and 4, respectively.

The cracks at the fusion lines, located approximately at (B), of weld deposits 116 produced with AA7085 weld filler alloys (FIGS. 26-27) are fewer in number and less extensive in comparison to the amount of cracking at the fusion lines of weld deposits 116 produced with AA2319 weld filler alloys (FIGS. 28-29). In other words, cracks within AA7085 weld deposits 116 (FIGS. 26-27) are generally fewer and smaller than cracks within AA2319 weld deposits 116 (FIGS. 28-29).

Weld deposits with thicknesses of at least about 51 mm (2 inch) can be used to restore mold plates having thicknesses of at least about 191 mm (7.5 inch). Specifically, restored portions produced from AA7085 weld filler alloys have fewer cracks than similarly restored portions produced from AA2319 weld filler alloys when restoring AA7085 mold plates. In addition, the length of cracks in weld deposits produced from AA7085 weld filler alloys are smaller and shorter than the length of cracks in weld deposits produced from AA2319 weld filler alloys.

### Example 4

### Weld Repairs of 7085 Mold Plate with AA7085 and AA2319 Weld Filler Alloys

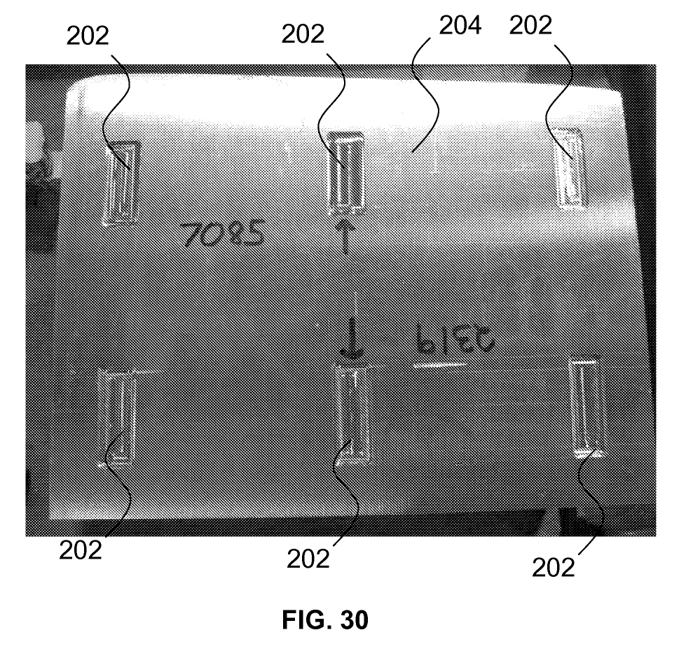

FIG. 30 shows a top perspective view of multiple defects 202 formed on a surface of a mold plate 204. The defects 202 can be produced by machining the mold plate 204 such that each defect 202 has a depth of about 3.2 mm (0.125 inch). The mold plate 204 has a thickness of about 191 mm (7.5 inch) and is made of AA7085. The defects 202 within the mold plate 204 can be used to demonstrate the characteristics of AA7085 and AA2319 weld filler alloys in repairing these defects 202.

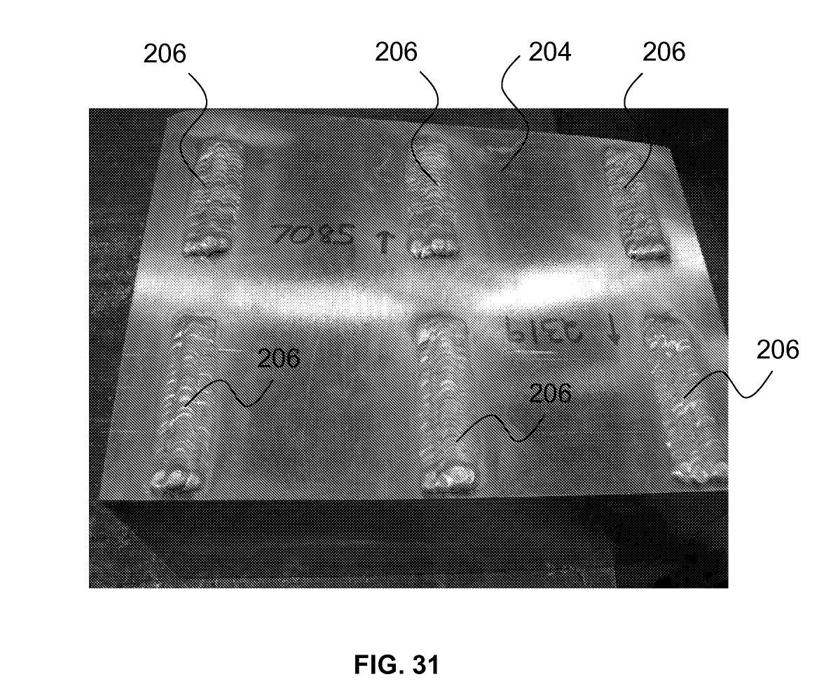

FIG. 31 shows a top perspective view of a weld repair process where filler alloys are deposited in the defects 202 to form weld deposits 206. The process conditions for depositing the filler alloys and forming the weld deposits 206 are similar to those shown in Table 2. The three weld deposits 206 on the upper half of the mold plate 204 correspond to Trial 1 while the three weld deposits 206 on the lower half of the mold plate 204 correspond to Trial 2. Like above, the defects 202 are subjected to similar pre-treatment processes as those described in Example 1 before the weld repair process. The pre-treatment processes include solvent cleaning, abrading with stainless steel brush, and solvent cleaning and drying for AC mode.

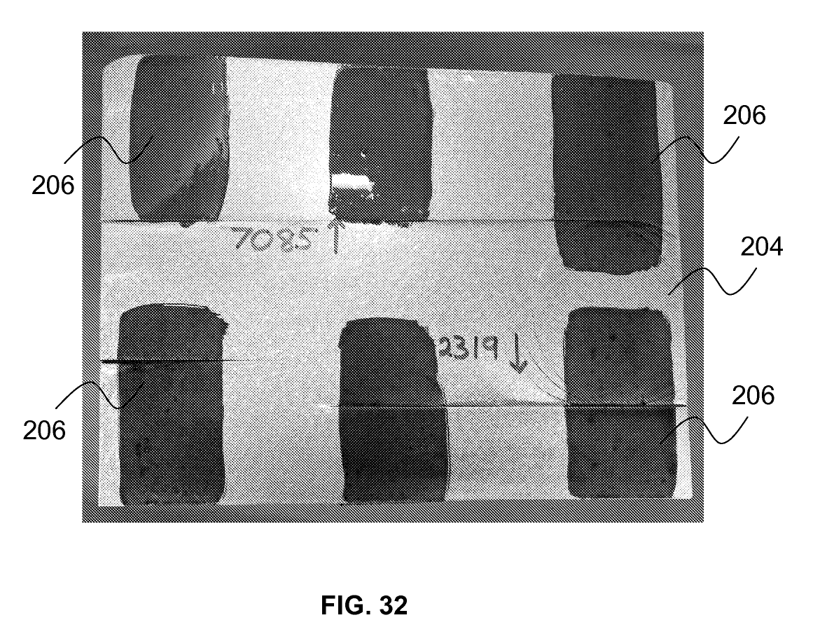

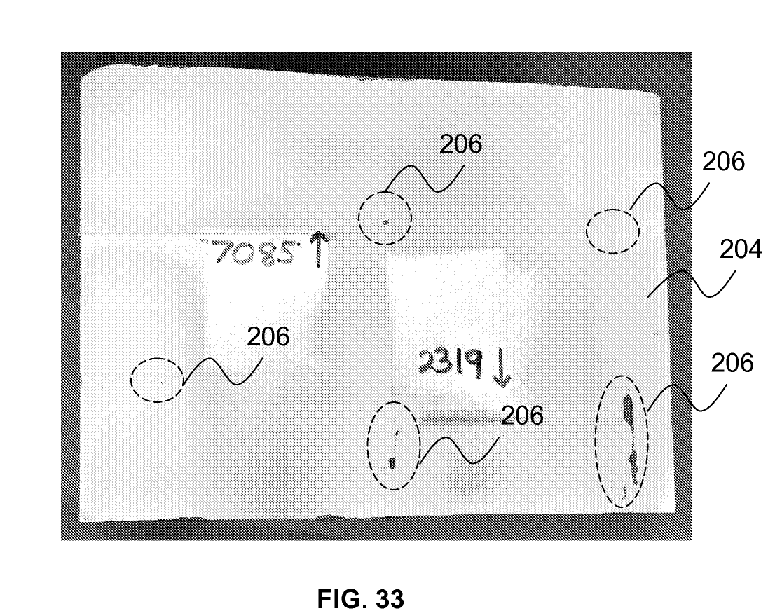

FIG. 32 shows a top perspective view of weld deposits 206 of FIG. 31 with a dye penetrant being applied at the top side to provide visual indications of cracking or other defects, after the weld deposits 206 have been machined to be flush with the top surface of the mold plate 204 such that the weld deposits 206 and the mold plate 204 are substantially planar. FIG. 33 shows a top perspective view of the surface of the mold plate 204 of FIG. 32 applied with a developer such that cracks within the weld deposits 206 can be highlighted and made more visible by the colored dye. The dye-penetrant inspection shows that cracks in weld deposits 206 from AA2319 weld filler alloys (bottom half) are generally wider and longer in length, and more visible than cracks in weld deposits 206 from AA7085 weld filler alloys (top half). As shown, cracks within the three weld deposits 206 associated with AA2319 weld filler alloys on the lower half of the mold plate 204 have been made more visible using the colored dye and developer in comparison to the three weld deposits 206 associated with AA7085 weld filler alloys on the upper half of the mold plate 204.

The average and maximum crack lengths of the weld deposits 206 as measured are summarized in Table 3.

TABLE 3
Average and Maximum Crack Lengths of Weld Deposits

| | AA7085 Weld | AA2319 Weld |
|---|---|---|
| Parameters | Filler Alloys | Filler Alloys |
| Average Crack Length | 3.3 mm (0.13 inch) | 30.5 mm (1.20 inch) |
| Maximum Crack Length | 3.8 mm (0.15 inch) | 47.5 mm (1.87 inch) |

Comparison of average and maximum crack lengths derived from the weld deposits 206 of FIG. 33 shows that cracks in weld deposits 206 produced with AA2319 weld filler alloys are at least an order of magnitude greater than weld deposits 206 produced with AA7085 filler alloys in terms of both average crack length (e.g., 30.5 mm vs. 3.3 mm) and maximum crack length (e.g., 47.5 mm vs. 3.8 mm).

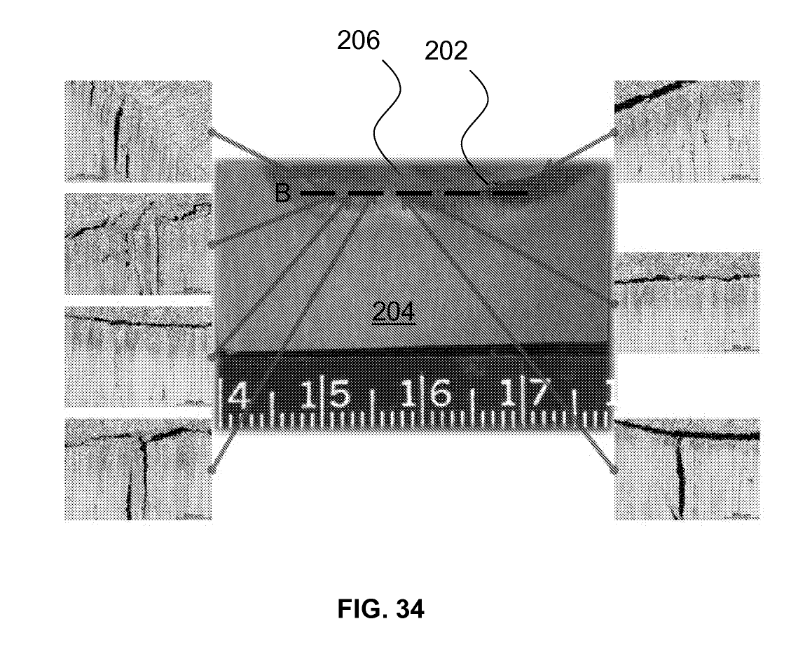

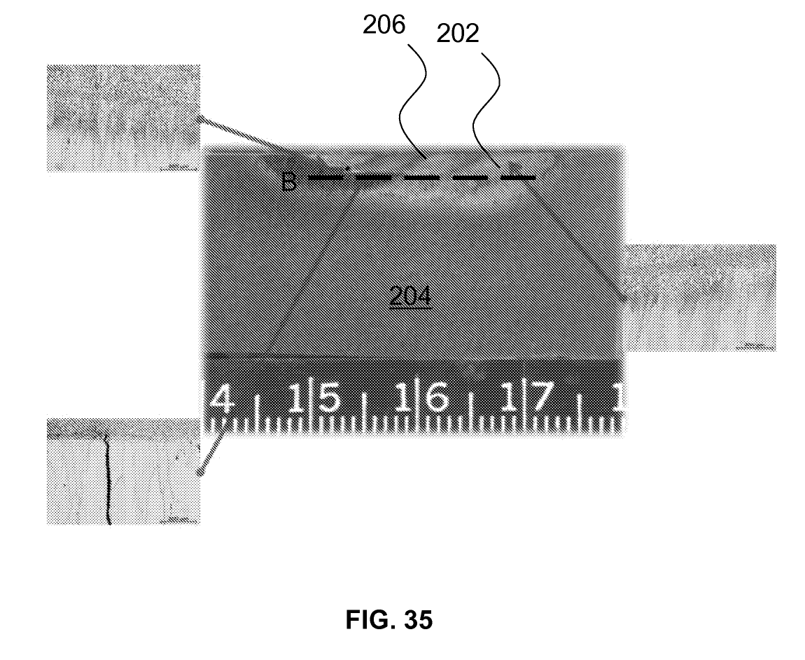

FIGS. 34-35 are cross-sectional macro/micrographs (15×/100×) of defects 202 repaired with weld deposits 206 using AA2319 weld filler alloys (FIG. 34) and AA7085 weld filler alloys (FIG. 35). The micrographs (100×) of surface defects 202 repaired with AA2319 weld filler alloys exhibit extensive cracking in comparison to the micrographs (100×) of surface defects 202 repaired with AA7085 weld filler alloys. Like above, the amount of cracking at the fusion lines near (B) of weld deposits 206 produced with AA7085 weld filler alloys (FIG. 35) are fewer in number and less extensive in comparison to the amount of cracking at the fusion lines near (B) of weld deposits 206 produced with AA2319 weld filler alloys (FIG. 34).

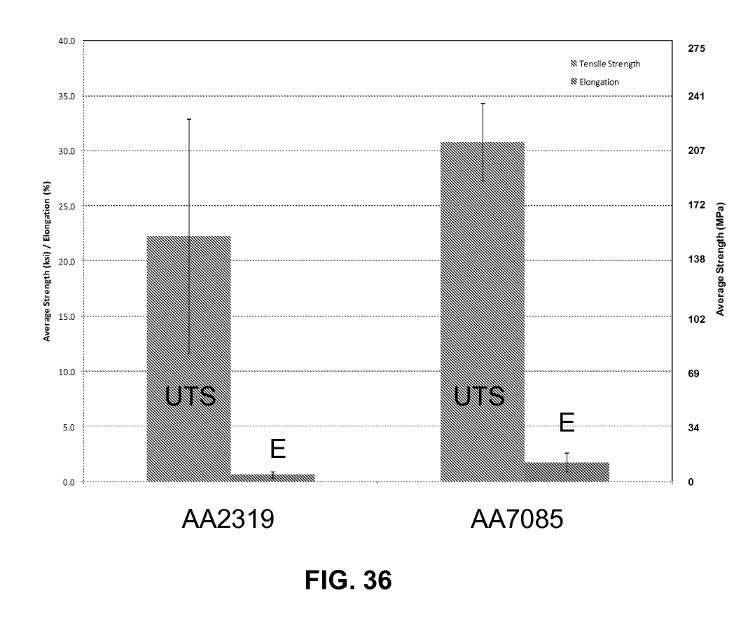

FIG. 36 is a graph showing the relationship between ultimate tensile strength (UTS) and elongation (E) of weld deposits using AA7085 and AA2319 weld filler alloys on AA7085 mold plates. The UTS measurements are transverse to the fusion lines (e.g., near (B)). As shown, weld deposits 206 produced from AA7085 weld filler alloys have UTS that are about 38% stronger than weld deposits 206 produced from AA2319 weld filler alloys. In addition, the standard of deviation for AA7085 is about three times narrower than AA2319. Most of the cracks in weld deposits 206 produced from AA7085 weld filler alloys are in the heat affected zones (HAZs) of the mold plate 204 along the grain boundaries and generally oriented nearly perpendicular to the fusion lines (e.g., near (B)), whereas most of the cracks in weld deposits 206 produced from AA2319 weld filler alloys are in both the fusion lines (e.g., near (B)) and the HAZs. Accordingly, weld deposits 206 produced with AA2319 weld filler alloys (FIG. 34) exhibit higher numbers of dye-penetrant crack indications along the edges and the fusion lines (e.g., near (B)) of the weld deposits 206 than weld deposits 206 produced with AA7085 weld filler alloys (FIG. 35).

Weld deposits with thicknesses of at least about 3.2 mm (0.125 inch) can be used to repair mold plates having thicknesses of at least about 191 mm (7.5 inch). Specifically, average and maximum crack lengths of repaired portions produced from AA7085 weld filler alloys are at least an order of magnitude less than similarly repaired portions produced from AA2319 weld filler alloys when repairing AA7085 mold plates. In addition, surface defects repaired with AA7085 weld filler alloys have UTS that are about 38% stronger than similar surface defects repaired with AA2319 weld filler alloys.

The above results for Examples 1-4 show that 7xxx series weld filler alloys may be used to repair 7xxx mold plates. The defects/discontinuities formed in mold plates described above may be the result of standard molding operations and may come in a variety of shapes and sizes. The defects/discontinuities may include one or more of a physical flaw, damage and/or crack on the surface of the mold plate. The resulting defects/discontinuities may render the mold plate substantially unusable. The improved weld deposit may be due to, at least in part, the substantially similar solidus temperatures between an AA7085 weld filler alloy and an AA7085 mold plate.

Furthermore, the micrographs of FIGS. 5-7 illustrate that a substantial reduction in cracking at the fusion lines and heat-affected zones may be achieved, for weld deposits produced with the AA7085 aluminum alloys weld filler alloys (FIGS. 6-7) compared to weld produced with the AA2319 aluminum alloy weld filler alloys (FIG. 5). In addition, reduced or restricted cracking may occur with the AA7085 weld filler alloys, but extensive cracking occurs with the AA2319 weld filler alloys. The standard for weld cracking may be measured in accordance with ASTM E165 “Recommended Practice for Liquid Penetrant Inspection Method.” In these instances, the more minimal the amount of cracking, the sounder are the surfaces of the weld deposits. In many cases, the more minimal amount of cracking in and about weld deposits may also be an indication that the welds are more soundly, metallurgically bonded to the unaffected mold plate adjacent to the defective volume that was removed as part of the weld repair.

In some instances, the microstructures of the welds produced with the AA7085 weld filler alloys may be more equiaxed (having axes of approximately the same length) than the microstructures of the welds produced with the AA2319 weld filler alloy, which appear to be dendritic (tree-like branching in all directions). In addition, the microstructure of the weld produced with the TiB₂ modified AA7085 weld filler alloy appears to be finer than the microstructure of the weld produced with the non-modified AA7085 aluminum alloy. The more equiaxed weld microstructures, in conjunction with the reduction in cracking, suggest that repair of defects/discontinuities in 7xxx mold plates may achieve better performance using substantially similar 7xxx weld filler alloys, rather than the industry standard 2319 weld filler alloy.

Visual inspection of the welds also reveal that welds produced with the AA7085 weld filler alloys have a more similar appearance to the 7xxx mold plate (or mold block) than that of the AA2319 repaired portion. This may prove useful for injection molding of plastic parts, for example, since objects produced with the 7xxx weld filler alloy repaired mold plate may be indistinguishable from those produced from a non-repaired mold plate. That is, the color and/or texture around the 7xxx repaired weld area may substantially similar to that of the original surface of the 7xxx mold plate.

Although only 7085 weld filler alloys were tested, it is anticipated that similar 7xxx weld filler alloys could be used to repair similar 7xxx mold plates. For example, it is anticipated that mold plates produced from AA7140 could be repaired with an AA7140 weld filler alloy. It is also anticipated that some mixing and matching may be completed, where an AA7140 mold plate could be repaired with an AA7085 weld filler alloy. Similar results may be achieved with other 7xxx weld filler alloys having relatively high amounts of copper (e.g., at least about 0.5 wt. %), and in contradistinction to the conventional wisdom. Other 7xxx weld filler alloys and 7xxx alloy product combinations may prove useful.

Irrespective of the type of 7xxx weld filler alloy that is utilized, the levels of weld discontinuities (e.g., cracks and pores) in the weld-repaired deposits should be acceptable to specific applications and conditions encountered in service. Some useful properties include, without limitation, high abrasion resistance, thermal and mechanical shock resistance, and material strength at elevated temperatures. Other characteristics include overall appearance, color match, pitting, adhesion and hardness. In one instance, the smoothness of the weld-repaired areas allows for ease of blending with adjoining surfaces of the mold plates.

In some instances, chemical compatibility of the 7xxx weld-repaired deposits with a 7xxx mold plate may be enhanced after texturing by chemical etching and/or mechanical abrasion. Texturizing may be carried out in order to restore a mold plate substantially to its original texture. In some embodiments, texturizing may be accomplished by mechanical denting, chemical etching, or combination of the two, among other techniques. The attempt to restore the mold plate to its original texture may be useful for control over the surfaces of the injection molded parts and preventing them from sticking to the mold plates during injection molding processes and the removal of the parts. In other words, restoring a mold plate to its original texture or having the fusion welding repair to be as close to the original texture as possible is useful to the object or plastic mold part produced so that the produced object has substantially the same texture on the appropriate outer surfaces of the produced object. In one embodiment, the new 7xxx weld filler alloys enable the production of a suitable texture of the 7xxx alloy product faster and easier than AA2319 weld filler alloys when used to repair 7xxx alloy products.

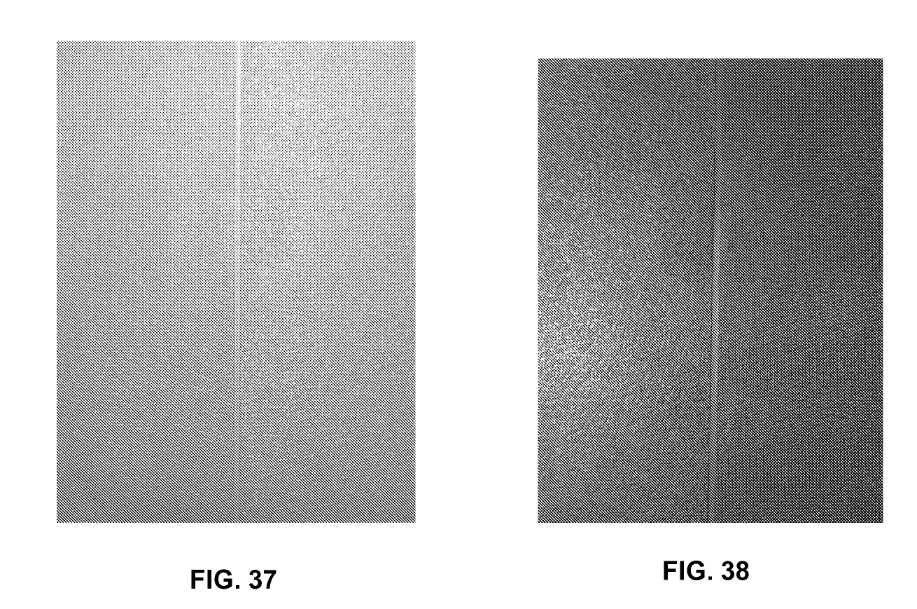

Reference is now made to FIG. 37 showing photographs of two different textured finishes of a repaired and grained AA7085 plaque (e.g., mold plate). The AA7085 plaque is filled and repaired with an AA7085 weld filler alloy. The left-side of FIG. 37 shows a geometric pattern texture while the right-side of FIG. 37 shows a simulated leather texture. As demonstrated, texturizing of the AA7085 weld-repaired deposits on an AA7085 plaque may enhance and substantially restore the AA7085 plaque to its original texture.

Reference is now made to FIG. 38 showing photographs of a resulting resin test of two different textured finishes of a repaired and grained AA7085 plaque (e.g., mold plate). The AA7085 plaque is filled and repaired with an AA7085 weld filler alloy. FIG. 38 shows the resulting finishes that would have appeared on a plastic component using the repaired and grained AA7085 plaque, which may be enhanced and substantially restored to its original texture and used to produce a correspondingly suitable texture on a resulting 7xxx alloy product.

In addition, AA7085 weld filler alloys can afford better color and grain matching following chemical retexturizing between repaired and unrepaired areas of the mold plate. Also, very little to no cracking may be observed in the weld deposits themselves, which mostly consist of cast structures. The little to no cracking in the multiple layers of weld deposits resulting from multiple passes may indicate that modified AA7085 weld filler alloys or other 7xxx series aluminum alloys may be incorporated in the weld deposition or repair processes.

One of the characteristics of judging chemical compatibility between base materials and filler alloys is the degree of discoloration imparted to the injection molded plastic parts upon their removal from the repaired mold plates. The discoloration of the parts may be caused by variations in the textured weld-repaired areas (e.g., the way the areas are etched compared to the original aluminum alloy mold plate), which can lead to visible changes to the way light is reflected and absorbed by the plastic parts and/or actual leaching of aluminum alloy(s) from the weld deposits into the plastic parts. In one embodiment, the weld-repaired areas produced from 7xxx weld filler alloys cause little or no discoloration to the production application products or parts. In addition, the degree of pitting of the weld-repair deposits during the chemical texturizing operation, which may increase the degree of sticking of the plastic and adversely affect the ease of removal from the mold plates and/or appearance of the parts, is restricted, and in some instance minimized or eliminated.

In one embodiment, a method of repairing a 7xxx mold plate with a 7xxx weld filler alloys may include: a) removing an affected (e.g., damaged, cracked, worn out) area on the mold plate (e.g., by grinding or machining), b) cleaning the area (e.g., with a solvent, drying, brushing with a stainless steel brush, solvent cleaning and drying again), c) “trough filling” or “building-up” (or restoring) the area to its original shape, by deposition of a 7xxx weld deposits on the top and adjacent to each other using the disclosed 7xxx alloy weld filler alloys (e.g., with the aid of manual gas tungsten arc welding process), for instance, and d) mechanical abrasion (e.g., grinding) of the weld deposit and adjacent areas of the unaffected mold plate so the weld deposit blends with its adjacent unaffected surfaces of the mold plate.

The quality and characteristics of the 7xxx weld-repaired areas and/or weld-repair techniques as previously described herein may be checked against injection molded plastic coupons that are produced of the plastic material of interest (e.g., polyethylene and polypropylene) with the injection molding conditions (e.g., texture of mold, injection mold's temperature and injection molding pressure) and having the desired surface characteristics (appearance, texture, uniformity of color and/or luster). These coupons are used as the “standard” against which the coupons produced after the weld-repair in question. By examining the “standard” coupons and the coupons produced with the repaired weld filler alloys and/or techniques being evaluated and comparing their surface characteristics, it is possible to judge the quality of the experimental coupons. The attributes that are compared include: a) general coupon appearance, b) texture and uniformity across the coupon (e.g., presence of dents), c) uniformity of color (color-match, and if there is not a good color-match between the “standard” and sample coupons and/or the surfaces of the sample coupon corresponding to the repaired areas and their adjacent unaffected mold surfaces) or luster, especially between the repaired area and its adjoining unaffected surfaces of the mold plate.

An additional benefit of using a 7xxx weld filler alloy to repair a 7xxx alloy product may include improved galvanic corrosion. For example, because 7xxx aluminum alloys have nearly the same solution-potential (e.g., electromotive potential) as the volumes weld repaired with the 7xxx weld filler alloys, there may be a lowered propensity for the repaired areas to galvanically corrode in various environments (e.g., storage in humid conditions) than the weld repaired volumes with a non-7xxx series weld filler alloys (e.g., AA2319).

In some instances, weld deposits formed using AA7085 weld filler alloys can be incorporated into GTAW processes because AA7085 weld filler alloys can be melted by the gas tungsten arc and achieve flow or viscosity comparable to AA2319 weld filler alloys. In addition, AA7085 weld filler alloys do not cause unusual disruptions in arc stability and generally yields geometrically consistent weld deposits (e.g., low levels of porosity).

AA7085 weld filler alloys can be used to restore AA7085 mold plates in both AC and DC welding modes. Welding in the AC mode may require a lower level of precaution in removing the surface oxides prior to welding in contrast to when welding in the DC mode.

The welding fumes emitted from arc welding of the filler alloys to the 7085 mold plate may require the use of efficient air ventilation (e.g., placement of exhaust ducts close to the welding area) to effectively remove zinc oxide and other fumes from the welding area.

Although the welding repair and mold plate repaired using the disclosed methods, systems and apparatus have been described in detail with reference to several embodiments, additional variations and modifications exist within the scope and spirit of the disclosure.

What is claimed is:

1. A method comprising:
(a) locating a surface defect of a mold block;
(i) wherein the surface defect has a first volume;
(ii) wherein the surface defect is at least partially surrounded by an original volume;
(iii) wherein the mold block includes the original volume;
(iv) wherein the mold block is made of a wrought aluminum alloy; and
(v) wherein the wrought aluminum alloy is a first 7xxx series aluminum alloy;
(b) repairing the surface defect, wherein the repairing comprises fusion welding a weld filler aluminum alloy to at least a portion of the original volume to produce a repaired volume;
(i) wherein the repaired volume includes the first volume of the surface defect and at least a portion of the original volume; and
(ii) wherein the weld filler aluminum alloy is a second 7xxx series aluminum alloy.

2. The method of claim 1, wherein the first 7xxx series aluminum alloy and the second 7xxx series aluminum alloy have substantially the same composition.

3. The method of claim 1, wherein the first 7xxx series aluminum alloy is selected from the group consisting of 7085, 7140, 7040, 7X36, 7X49, 7X50, 7055, 7056, 7X75, 7081, and 7095.

4. The method of claim 1, wherein the first and second 7xxx series aluminum alloys include at least about 0.5 wt. % Cu.

5. The method of claim 4, wherein the first and second 7xxx series aluminum alloys include at least about 1.0 wt. % Cu.

6. The method of claim 5, wherein the first and second 7xxx series aluminum alloys include from about 6.0 wt. % Zn to about 9.5 wt. % Zn and from about 1.0 wt. % Mg to about 3.1 wt. % Mg.

7. The method of claim 1, after the repairing step (b), producing a molded object via the mold block, wherein the molded object has substantially the same color throughout its outer surface.

8. The method of claim 7, wherein, the molded object has substantially the same texture throughout its outer surface.

9. The method of claim 1, wherein, after the repairing step (b), the repaired volume is substantially crack-free.

10. The method of claim 1, wherein the fusion welding comprises:
building up a repaired layer to a thickness of at least about 0.25 inch above the outer surface of the mold block.

11. The method of claim 10, wherein after the building step, the repaired layer has a thickness of at least about 1 inch above the outer surface of the mold block.

12. A 7xxx injection mold block having features suited for the production of injection mold parts,
wherein the injection mold block consists essentially of a 7xxx aluminum alloy,
wherein the injection mold block comprises a repaired volume and an adjacent original volume,
wherein the repaired volume comprised a 7xxx weld filler alloy that is welded to the original volume, and
wherein the repaired volume is substantially crack-free.

13. A 7xxx injection mold block having features suited for the production of injection mold parts,
wherein the injection mold block consists essentially of a 7xxx aluminum alloy,
wherein the injection mold block comprises a repaired volume and an adjacent original volume,
wherein the repaired volume comprised a 7xxx weld filler alloy that is welded to the original volume,
wherein the repaired volume has an average height that is at least about 0.25 inch higher than that of the original volume, and
wherein the repaired volume has an ultimate tensile strength of at least about 170 MPa.
